(19) United States
(12) Patent Application Publication
(10) Pub. No.: US 2008/0055632 A1
(43) Pub. Date: Mar. 6, 2008

(54) Information processing apparatus, communication system, and recording medium storing information processing apparatus program, and computer data signal embodied in carrier wave

(75) Inventors: Makoto Oshiumi, Saitama (JP); Hiroshi Shiraku, Saitama (JP); Hiroshi Doi, Saitama (JP); Yoshihito Oono, Saitama (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 11/727,505

(22) Filed: Mar. 27, 2007

(30) Foreign Application Priority Data
Aug. 31, 2006 (JP) 2006-236186

(51) Int. Cl. G06F 3/12

(52) U.S. Cl. 358/1.15

(57) ABSTRACT

An information processing apparatus, which includes: a device search section that searches a device connected through a communication section; a radio field intensity acquisition section that acquires from the device searched by the device search section a radio field intensity of the device for wireless communication with the communication section; a device selection section that selects a device in accordance with the radio field intensity acquired by the radio field intensity acquisition section; a device control program acquisition section that acquires a device control program for the device selected by the device selection section; and a device control program setting section that sets the device control program acquired by the device control program acquisition section so as to be available.

### CROSS-REFERENCE TO RELATED APPLICATION

This application is based on and claims priority under 35 USC 119 from Japanese Patent Application No. 2006-236186 filed on Aug. 31, 2006.

### BACKGROUND

1. Technical Field

The present invention relates to an information processing apparatus, a communication system, a recording medium storing an information processing apparatus program and a computer data signal embodied in a carrier wave.

2. Related Art

In general, to install software (hereinafter referred to as a “device driver”) for operating peripheral apparatuses such as a printer, a scanner or a harddisk drive to an information processing apparatus such as a personal computer, an install program is used for the installation process. In this case, after the peripheral apparatuses connected to a network are listed up and a user selects a peripheral apparatus to be used, the install program obtains a device driver that the selected peripheral apparatus holds, and the device driver for the peripheral apparatus selected by the user is installed to the information processing apparatus.

In recent years, peripheral devices capable of performing wireless communication using radio wave, or the like have been provided. Additionally, peripheral devices which are connected by wireless communication have been disposed on the network.

### SUMMARY

An information processing apparatus, includes a device search section that searches a device connected through a communication section; a radio field intensity acquisition section that acquires from the device searched by the device search section a radio field intensity of the device for wireless communication with the communication section; a device selection section that selects a device in accordance with the radio field intensity acquired by the radio field intensity acquisition section; a device control program acquisition section that acquires a device control program for the device selected by the device selection section; and a device control program setting section that sets the device control program acquired by the device control program acquisition section so as to be available.

### BRIEF DESCRIPTION OF THE DRAWINGS

Exemplary embodiments of the present invention will be described in detail with reference to the following figures, wherein:

FIG. 1 is a system configuration diagram illustrating an example of an entire configuration of a communication system pertaining to the present invention;

FIG. 2 is a block diagram illustrating an example of a functional configuration of a PC and a wireless printer;

FIG. 3 is a flowchart illustrating a flow of operation of a printer driver install program in a case where printer drivers are to be acquired from all wireless printers in a printers list;

FIG. 4 is a flowchart illustrating a flow of operation of the printer driver install program in a case where the printer drivers are to be acquired from a wireless printer selected from the printers list by a user;

FIG. 5 is a figure illustrating an example of a printers list which is displayed on a display apparatus;

FIG. 6 is a block diagram illustrating an example of a functional configuration of the PC and the wireless printer;

FIG. 7 is a flowchart illustrating a flow of operation of the printer driver install program in a case where the printer drivers are to be acquired from all of the wireless printers in the printers list;

FIG. 8 is a flowchart illustrating a flow of operation of the printer driver install program in a case where the printer driver is to be acquired from the wireless printer selected from the printers list by the user;

FIG. 9 is a block diagram illustrating an example of a functional configuration of the PC and the wireless printer;

FIG. 10 is a flowchart illustrating a flow of operation of the printer driver acquisition program in a case where the printer drivers are to be acquired from all of the wireless printers in the printers list;

FIG. 11 is a flowchart illustrating a flow of operation of the printer driver acquisition program in a case where the printer driver is to be acquired from the wireless printer selected from the printers list by the user;

FIG. 12 is a block diagram illustrating an example of a functional configuration of the PC and the wireless printer;

FIG. 13 is a flowchart illustrating a flow of operation of the printer driver acquisition program in a case where the printer drivers are to be acquired from all of the wireless printers in the printers list;

FIG. 14 is a flowchart illustrating a flow of operation of the printer driver acquisition program in a case where the printer driver is to be acquired from the wireless printer selected from the printers list by the user;

FIG. 15 is a block diagram illustrating an example of a functional configuration of the PC and the wireless printer;

FIG. 16 is a flowchart illustrating a flow of operation of the printer driver install program in a case where each of the printer drivers for each of the wireless printers in the printers list is to be acquired;

FIG. 17 is a flowchart illustrating a flow of operation of the printer driver install program in a case where the printer driver for the wireless printer selected from the printers list by the user is to be acquired;

FIG. 18 is a block diagram illustrating an example of a functional configuration of the PC and the wireless printer;

FIG. 19 is a flowchart illustrating a flow of operation of the printer driver install program in a case where the printer drivers for all the wireless printers in the printers list is to be acquired;

FIG. 20 is a flowchart illustrating a flow of operation of the printer driver install program in a case where the printer driver for the wireless printer selected from the printers list by the user is to be acquired;

FIG. 21 is a block diagram illustrating an example of the functional configuration of the PC and the wireless printer;

FIG. 22 is a flowchart illustrating a flow of operation of the printer driver acquisition program in a case where the printer drivers for all the wireless printers in the printers list is to be acquired;

FIG. 23 is a flowchart illustrating a flow of operation of the printer driver acquisition program in a case where the printer driver for the wireless printer selected from the printers list by the user is to be acquired;

FIG. 24 is a block diagram illustrating an example of a functional configuration of the PC 2 and the wireless printer;

FIG. 25 is a flowchart illustrating a flow of operation of the printer driver acquisition program in a case where the printer drivers for all the wireless printers in the printers list is to be acquired; and

FIG. 26 is a flowchart illustrating a flow of operation of the printer driver acquisition program in a case where the printer driver for the wireless printer selected from the printers list by the user is to be acquired.

### DETAILED DESCRIPTION

Hereinbelow, exemplary embodiments of an information processing apparatus, a communication system, a recording medium storing information processing apparatus program and a computer data signal embodied in a carrier wave pertaining to the present invention will be described with reference to the attached drawings. In these exemplary embodiments, a configuration in which the information processing apparatus program pertaining to the present invention is installed in an information processing apparatus, such as a personal computer, or the like, (hereinafter referred to as a “PC”) will be described as an example.

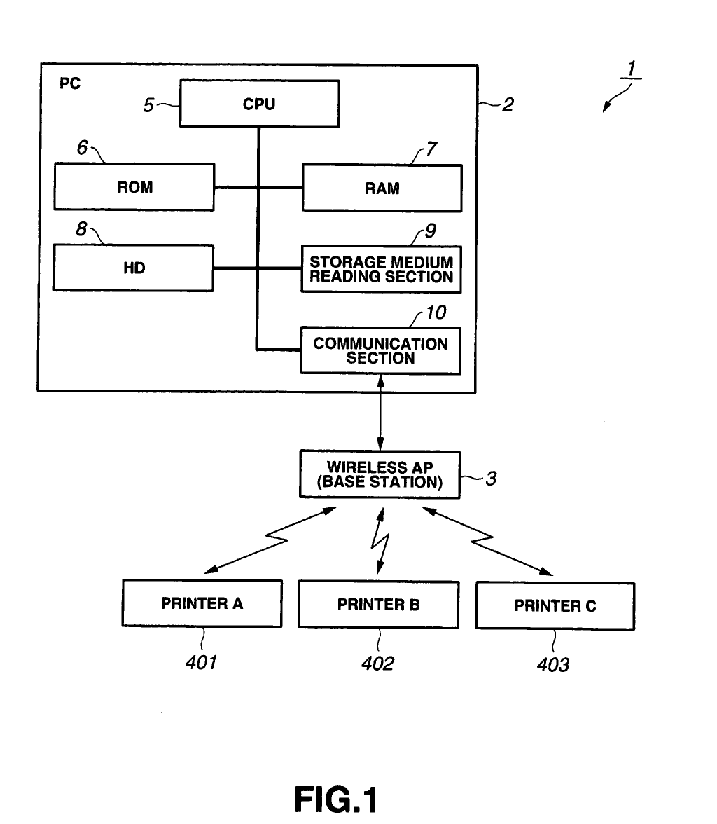

FIG. 1 is a system configuration diagram illustrating an example of an entire configuration of a communication system 1 pertaining to the present invention.

As shown in FIG. 1, the communication system 1 includes a PC 2, a wireless access point 3 which is operated as a base station for wireless communication (hereinafter referred to as a “wireless AP”), and a plurality of printers (401, 402, 403). With the communication system 1 as shown in the same figure, only a part thereof is shown, and actually, other apparatuses are connected to the communication system 1 in different connection styles (wired and wireless).

A printer A 401, a printer B 402 and a printer C 403 are printers which are operating in the communication system 1, and they are wireless printers which perform wireless communication with the wireless AP 3 providing a base station. Each of the printer A 401, the printer B 402 and the printer C 403 holds its own device control program (hereinafter referred to as a “printer driver”).

Next, the hardware configuration of the PC 2 will be described.

As shown in FIG. 1, the PC 2 includes a CPU 5, an ROM 6, an RAM 7, an HD 8 and a communication section 10.

The CPU (Central Processing Unit) 5 performs sequential control of the main body of the PC 2 on the basis of an operating system (hereinafter referred to as an “OS”), which is basic software; the ROM (Read Only Memory) 6 records a program, and the like, which are implemented at the time of starting up the PC 2; the RAM (Random Access Memory) 7 is utilized as a buffer area for the working area necessary for implementing the program; the HD (Hard Disk) 8 stores the OS, an application program, the information processing apparatus program pertaining to the present invention, and data for various files, and the like; a storage medium reading section reads out information stored on storage media, such as various memories, optical disks, and the like; and the communication section 10 performs transmission and reception of various data with the printers (401, 402, 403), other apparatuses, and the like. The connection style between the PC 2 and the wireless AP 3 may be either wired or wireless.

### First Exemplary Embodiment

In a first exemplary embodiment, an example will be described in which the information processing apparatus program (hereinafter referred to as the “printer driver install program”) pertaining to the present invention, which is installed in the PC 2, identifies a wireless printer with which wireless communication are to be performed, on the basis of whether there is a radio field intensity for wireless communication, and acquires the printer driver from the wireless printer to install the printer driver into the PC 2.

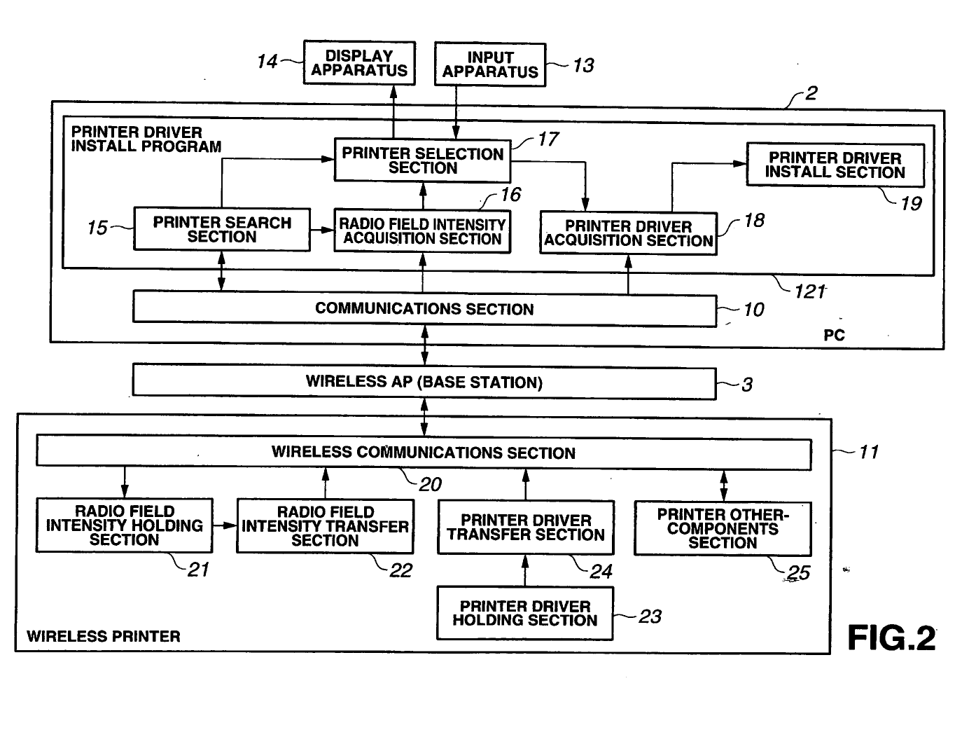

FIG. 2 is a block diagram illustrating an example of the functional configuration of the PC 2 and the wireless printer 11.

First, the functional configuration of the PC 2 will be described.

As shown in FIG. 2, a printer driver install program 121 and various types of application software (not shown) for implementing application programs are installed in the PC 2, and these utilize the functions of the OS (not shown) for implementing various types of process under the control of the OS. In addition, input apparatuses 13, such as a keyboard and a mouse, and a display apparatus 14, such as a display, are connected to the PC 2. The components other than the above-described components of the PC 2 are not shown, and thus description thereof is omitted.

Next, the functional configuration of the printer driver install program 121 will be described.

As shown in FIG. 2, the printer driver install program 121 includes a printer search section 15, a radio field intensity acquisition section 16, a printer selection section 17, a printer driver acquisition section 18, and a printer driver install section 19 as the functions thereof.

The printer search section 15 searches out a printer connected to the PC 2 regardless of whether the connection is wired or wireless.

The radio field intensity acquisition section 16 acquires the radio field intensity (or the communication level) for wireless communication from the printer searched out by the printer search section 15. Herein, from a printer which will not perform wireless communication, in other words, that of wired connection, the radio field intensity cannot be acquired, thus a printer from which the radio field intensity cannot be acquired is regarded as that of wired connection at this point of time, and the printer driver install program 121 will not acquire the printer driver from the printer which is regarded as a printer of wired connection.

The printer selection section 17 compares the radio field intensity acquired from the wireless printer 11 with a prescribed value (hereinafter referred to as a “threshold value”) to select and enter into a list (hereinafter referred to as a “printers list”) the wireless printer 11 having a radio field intensity higher than the threshold value as the wireless printer 11 of which printer driver is to be installed. The user can set the threshold value.

The printer driver acquisition section 18 acquires the printer driver from the wireless printer 11 in the list of the printers selected by the printer selection section 17. The printer driver may be acquired from all the wireless printers 11 in the list of the printers selected by the printer selection section 17, or the list of the printers selected by the printer selection section 17 may be displayed on the display apparatus 14 for the user to employ the input apparatus 13 for selection of the wireless printer 11 of which printer driver is to be installed, from the printers list displayed on the display apparatus 14, the printer driver being acquired from the wireless printer 11 selected by the user.

The printer driver install section 19 installes the printer driver acquired by the printer driver acquisition section 18 into the PC 2.

Next, the functional configuration of the wireless printer 11 will be described.

As shown in FIG. 2, the wireless printer 11 includes a wireless communication section 20, a radio field intensity holding section 21, a radio field intensity transfer section 22, a printer driver holding section 23, a printer driver transfer section 24, and a printer other-components section 25.

The wireless communication section 20 performs wireless communication with the wireless AP 3, and the like, being configured to include an antenna, transmission and reception circuits, a measuring circuit for radio field intensity, and the like. For radio field intensity, utilization of the RSSI (Received Signal Strength Indication, which is a numerical indication of the intensity of a radio wave signal being received) or the S/N ratio (Signal to Noise Ratio) which is generally held by a wireless communication apparatus as surrounding information for carrying out range division on the basis of the measurement of the radio field intensity is known as a well-known technology.

The radio field intensity holding section 21 is a storage region for holding the radio field intensity measured by the wireless communication section 20.

The radio field intensity transfer section 22 transfers the radio field intensity held in the radio field intensity holding section 21 to the PC 2 when a radio field intensity request is received from the PC 2 (in other words, the printer driver install program 121).

The printer driver holding section 23 is a storage region for holding the printer driver.

The printer driver transfer section 24 transfers the printer driver held in the printer driver holding section 23 to the PC 2 when a printer driver request is received from the PC 2 (in other words, the printer driver install program 121).

The printer other-components section 25 is a general components section constituting the wireless printer 11.

The holding of the radio field intensity by the wireless printer 11 and the transferring of the radio field intensity from the wireless printer 11 to the PC 2 are carried out by taking the procedure of, for example, that the wireless printer 11 holds the radio field intensity as the MIB (Management Information Base); the printer driver install program 121 requests the radio field intensity of the wireless printer 11 under the SNMP (Simple Network Management Protocol); and the wireless printer 11 acquires the radio field intensity from the MIB, and notifies the printer driver install program 121 of the contents thereof.

Next, the operation of the printer driver install program 121 and that of the wireless printer 11 will be described.

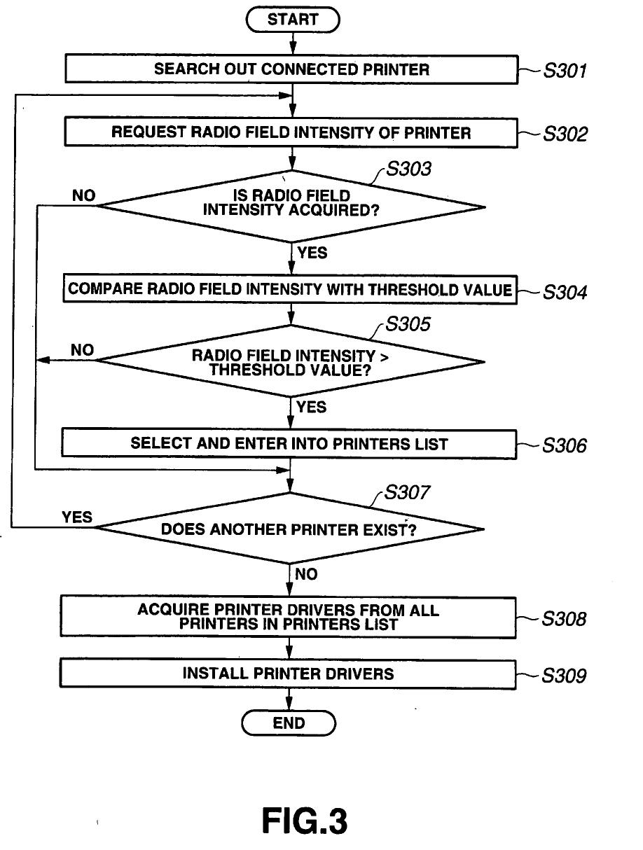

FIG. 3 is a flowchart illustrating the flow of operation of the printer driver install program in a case where the printer drivers are to be acquired from all the wireless printers in the printers list.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When the printer driver install program is activated, the printer search section searches out a printer which is connected to the PC regardless of whether the connection is wired or wireless (S301); the radio field intensity acquisition section requests the radio field intensity of the searched-out printer (S302); and in a case where the radio field intensity is acquired (YES at S303), the system proceeds to S304, while, in a case where the radio field intensity cannot be acquired (NO at S303), the system proceeds to S307.

In a case where the radio field intensity is acquired (YES at S303), the printer selection section compares the acquired radio field intensity with the threshold value (S304), and in a case where the radio field intensity is higher than the threshold value (YES at S305), the system proceeds to S306, while, in a case where the radio field intensity is lower than the threshold value (NO at S305), the system proceeds to S307.

In a case where the radio field intensity is higher than the threshold value (YES at S305), the printer selection section selects the printer having the radio field intensity to enter it into the printers list (S306), the system proceeding to S307.

And, in a case where another printer exists (YES at S307), the system returns to S302, while, in a case where no other printer exists (NO at S307), the system proceeds to S308.

In a case where no other printer exists (NO at S307), the printer driver acquisition section acquires the printer drivers from all the printers in the printers list (S308), and the printer driver install section implements installation of the acquired printer drivers (S309), the system terminating the installation process.

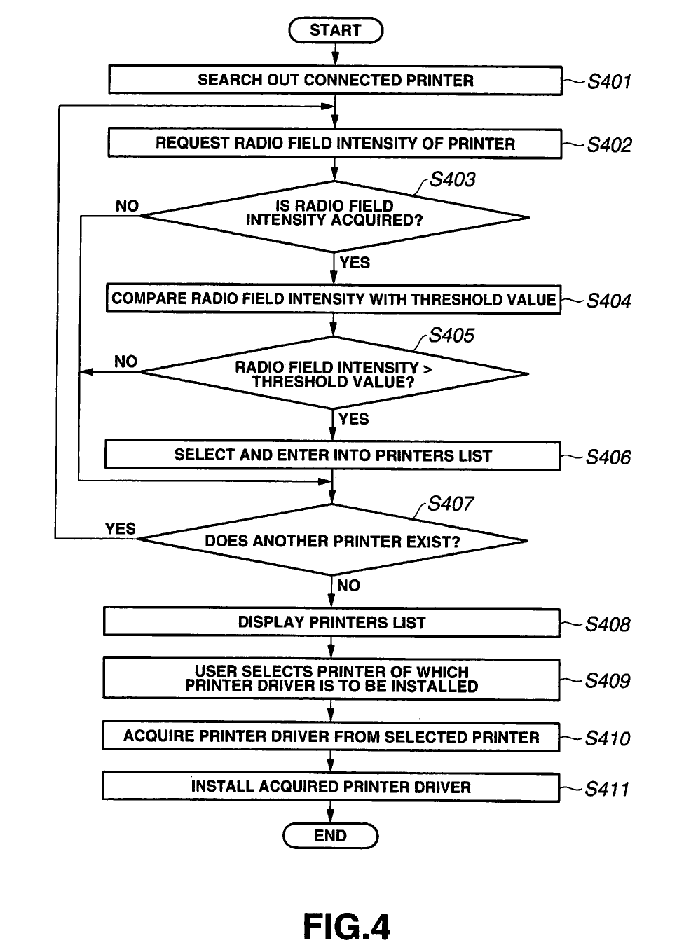

FIG. 4 is a flowchart illustrating the flow of operation of the printer driver install program in a case where the printer driver is to be acquired from the wireless printer selected from the printers list by the user.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When the printer driver install program is activated, the printer search section searches out a printer which is connected to the PC regardless of whether the connection is wired or wireless (S401); the radio field intensity acquisition section requests the radio field intensity of the searched-out printer (S402); and in a case where the radio field intensity is acquired (YES at S403), the system proceeds to S404, while, in a case where the radio field intensity can be acquired (NO at S403), the system proceeds to S407.

In a case where the radio field intensity is acquired (YES at S403), the printer selection section compares the acquired radio field intensity with the threshold value (S404), and in a case where the radio field intensity is higher than the threshold value (YES at S405), the system proceeds to S406, while, in a case where the radio field intensity is lower than the threshold value (NO at S405), the system proceeds to S407.

In a case where the radio field intensity is higher than the threshold value (YES at S405), the printer selection section selects the printer having the radio field intensity to enter it into the printers list (S406), the system proceeding to S407.

And, in a case where another printer exists (YES at S407), the system returns to S402, while, in a case where no other printer exists (NO at S407), the system proceeds to S408.

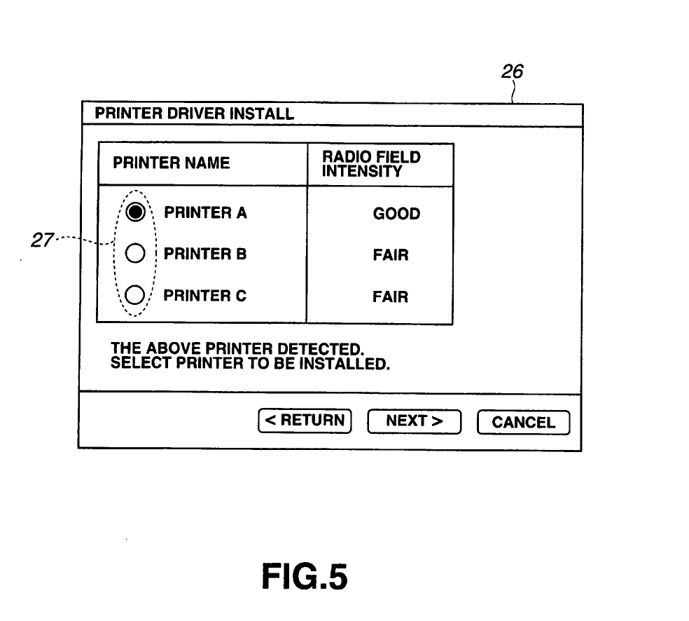

In a case where no other printer exists (NO at S407), a printers list is displayed on the display apparatus (S408). The printers list is displayed on, for example, the screen 26 as shown in FIG. 5. By means of the screen 26 in the same figure, the user identifies the wireless printer of which printer driver can be installed and of which radio field intensity level is high, and from the screen 26 in the same figure, the user selects the wireless printer of which printer driver is to be installed (specifically, the user enters a check mark into the check box corresponding to the desired wireless printer). The way of arrangement of the wireless printers displayed on the screen 26 as shown in the same figure provides one example, and any other way of arrangement may be provided through design alteration.

And, the user selects the printer of which printer driver is to be installed (S409); the printer driver acquisition section acquires the printer driver from the selected printer (S410); and the printer driver install section implements installation of the acquired printer driver (S411), the system terminating the installation process.

The printer driver install program can be supplied by being stored on storage media, such as various memories, optical disks, and can also be distributed through a communication line.

### Second Exemplary Embodiment

In a second exemplary embodiment, a description will be made as an example in which the information processing apparatus program (hereinafter referred to as the “printer driver install program”) pertaining to the present invention, which is installed in the PC 2, identifies a wireless printer with which wireless communication are to be performed, by identifying the connection style of the printer to be connected, and acquires the printer driver from the wireless printer to install the printer driver into the PC 2.

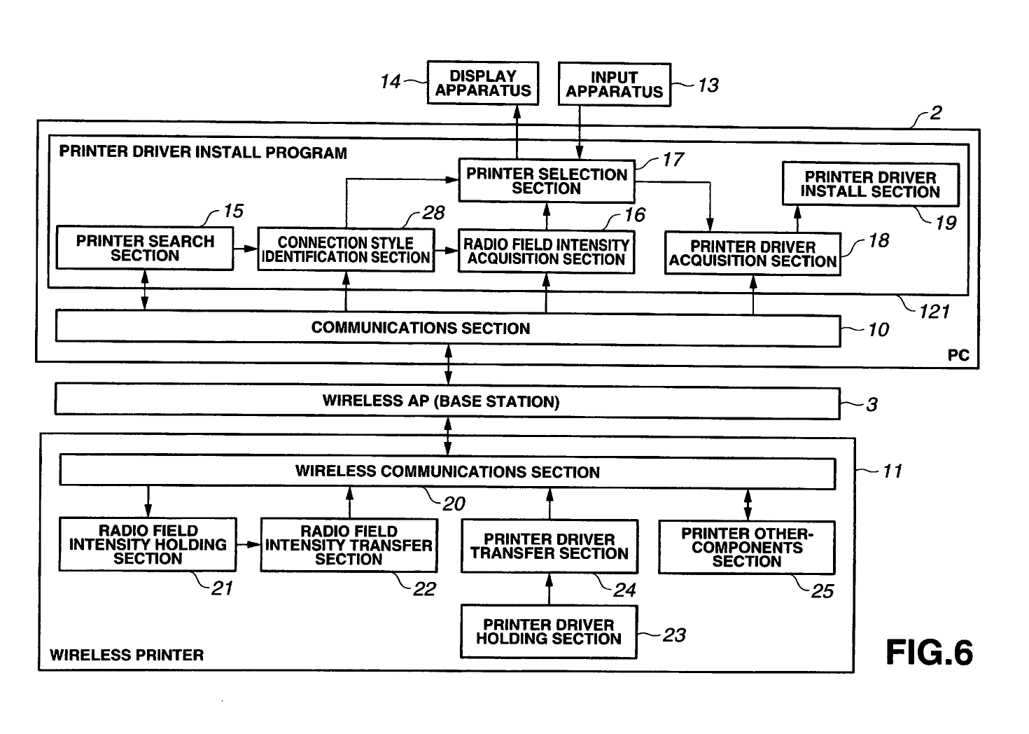

FIG. 6 is a block diagram illustrating an example of a functional configuration of the PC 2 and the wireless printer 11.

First, the functional configuration of the PC 2 will be described.

As shown in FIG. 6, a printer driver install program 121 and various types of application software (not shown) for realizing application programs are installed in the PC 2, and these utilize the functions of the OS (not shown) for implementing various types of process under the control of the OS. In addition, input apparatuses 13, such as a keyboard and a mouse, and a display apparatus 14, such as a display, are connected to the PC 2. The components other than the above-described components of the PC 2 are not shown, and thus description thereof is omitted.

Next, the functional configuration of the printer driver install program 121 will be described.

As shown in FIG. 6, the printer driver install program 121 includes a printer search section 15, a connection style identification section 28, a radio field intensity acquisition section 16, a printer selection section 17, a printer driver acquisition section 18, and a printer driver install section 19 as the functions thereof.

The printer search section 15 searches out a printer connected to the PC 2 regardless of whether the connection is wired or wireless.

The connection style identification section 28 identifies the connection style of the printer searched out by the printer search section 15 (in other words, whether the connection is wireless or wired). Herein, the printer driver install program 121 does not acquire the printer driver from the printer which connection style is identified to be wired.

The radio field intensity acquisition section 16 acquires the radio field intensity (or the communication level) for wireless communication from the wireless printer 1 of which connection style is identified to be wireless by the connection style identification section 28.

The printer selection section 17 compares the radio field intensity acquired from the wireless printer 11 with a prescribed value (hereinafter referred to as a “threshold value”) to select and enter into a list (hereinafter referred to as a “printers list”) the wireless printer 11 having a radio field intensity higher than the threshold value as the wireless printer 11 of which printer driver is to be installed. The user can set the threshold value.

The printer driver acquisition section 18 acquires the printer driver from the wireless printer 11 selected by the printer selection section 17 and entered into the printers list. There may be two cases to acquire the printer driver: the first case is that the printer driver is acquired from all the wireless printers 11 in the printers list selected by the printer selection section 17; and, the second case is that the printer driver is acquired from the wireless printer 11 selected by the user in a way that the wireless printers in the printers list selected by the printer selection section 17 are displayed on the display device 14, and using the input device 13, the user selects from the printers list displayed on the display device 14 the wireless printer 11 of which the printer driver is to be installed.

The printer driver install section 19 installs into the PC 2 the printer driver acquired by the printer driver acquisition section 18.

The functional configuration of the wireless printer 11 is the same as that of the wireless printer 11 as described in the first exemplary embodiment, thus description thereof is omitted herein.

Next, the operation of the printer driver install program 121 and that of the wireless printer 11 will be described.

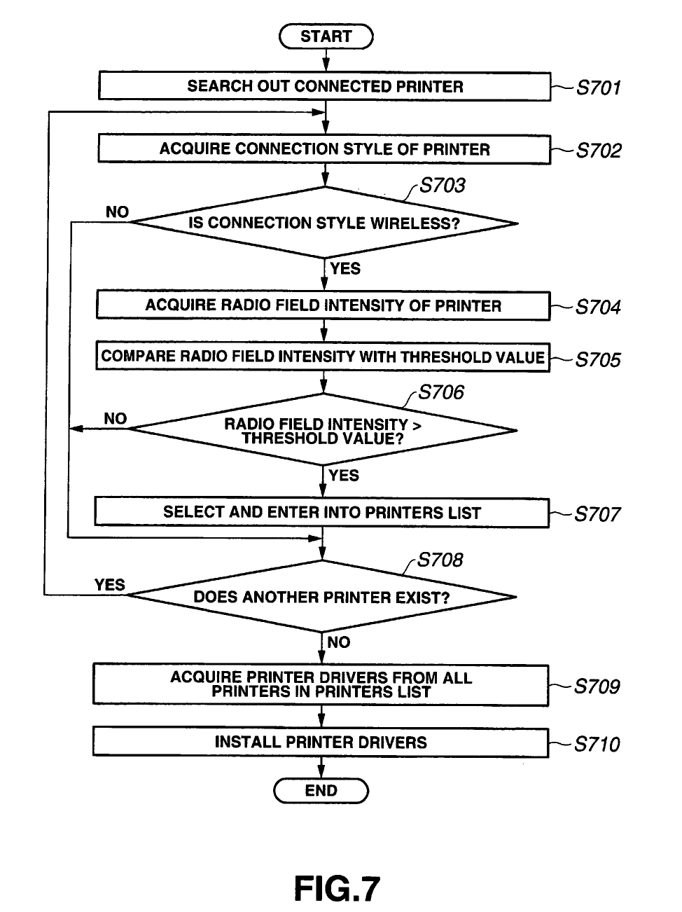

FIG. 7 is a flowchart illustrating the flow of operation of the printer driver install program in a case where the printer driver is to be acquired from all the wireless printers in the printers list.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When the printer driver install program is activated, the printer search section searches out a printer which is connected to the PC regardless of whether the connection is wired or wireless (S701); the connection style identification section acquires the connection style from the searched-out printer (S702); in a case where the connection style is identified to be wireless (YES at S703), the system proceeds to S704, while, in a case where the connection style is identified to be wired (NO at S703), the system proceeds to S708.

In a case where the connection style is identified to be wireless (YES at S703), the radio field intensity acquisition section requests the radio field intensity of the printer identified to be wireless (S704); the printer selection section compares the acquired radio field intensity with the threshold value (S705); in a case where the radio field intensity is higher than the threshold value (YES at S706), the system proceeds to S707, while, in a case where the radio field intensity is lower than the threshold value (NO at S706), the system proceeds to S708.

In a case where the radio field intensity is higher than the threshold value (YES at S706), the printer selection section selects the printer having the radio field intensity higher than the threshold value to enter it into the printers list (S707), the system proceeding to S708.

And, in a case where another printer exists (YES at S708), the system returns to S702, while, in a case where no other printer exists (NO at S708), the system proceeds to S709.

In a case where no other printer exists (NO at S708), the printer driver acquisition section acquires the printer driver from all the printers in the printers list (S709), and the printer driver install section installs the acquired printer drivers (S710), the system terminating the installation process.

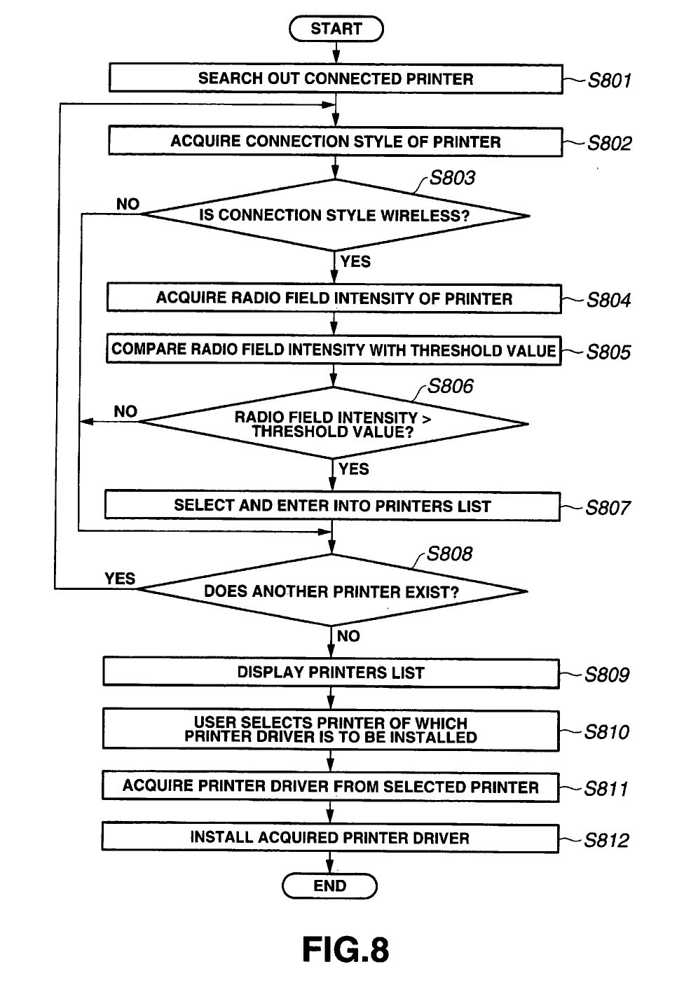

FIG. 8 is a flowchart illustrating the flow of operation of the printer driver install program in a case where the printer driver is to be acquired from the wireless printer selected from the printers list by the user.

The printer driver install program is generally activated by the user instruction (for example, an instruction given by clicking the icon representing the printer driver install program displayed on the desktop of the PC, an instruction given by clicking the printing pushbutton prepared by an application program during data processing carried out thereby, or the like), however, in a case where the printer driver install program is a resident program, the install program may be activated at the time of system start-up.

When the printer driver install program is activated, the printer search section searches out a printer which is connected to the PC regardless of whether the connection is wired or wireless (S801); the connection style identification section acquires the connection style from the searched-out printer (S802); in a case where the connection style is identified to be wireless (YES at S803), the system proceeds to S804, while, in a case where the connection style is identified to be wired (NO at S803), the system proceeds to S808.

In a case where the connection style is identified to be wireless (YES at S803), the radio field intensity acquisition section requests the radio field intensity of the printer identified to be wireless (S804); the printer selection section compares the acquired radio field intensity with the threshold value (S805); in a case where the radio field intensity is higher than the threshold value (YES at S806), the system proceeds to S807, while, in a case where the radio field intensity is lower than the threshold value (NO at S806), the system proceeds to S808.

In a case where the radio field intensity is higher than the threshold value (YES at S806), the printer selection section selects the printer having the radio field intensity to enter it into the printers list (S807), the system proceeding to S808.

And, in a case where another printer exists (YES at S808), the system returns to S802, while, in a case where no other printer exists (NO at S808), the system proceeds to S809.

In a case where no other printer exists (NO at S808), a printers list is displayed on the display apparatus (S809). The printers list is displayed on, for example, the screen 26 as shown in FIG. 5.

And, the user selects the printer of which printer driver is to be installed (S810); the printer driver acquisition section acquires the printer driver from the selected printer (S811); and the printer driver install section implements installation of the acquired printer driver (S812), the system terminating the installation process.

The printer driver install program can be supplied by storing on a storage medium, such as various memories and optical disks, and can also be distributed through a communication line.

A communication system includes at least one device connected through a communication section, and an information processing apparatus that controls the device via the communication section, in which the device includes: a wireless communication control section connected to the communication section through wireless communication; a radio field intensity holding section that holds the radio field intensity for the wireless communication; a radio field intensity holding section that holds the radio field intensity for the wireless communication; a wireless communication notification section that, according to a request from the information processing apparatus for notification of the style of the connection with the communication section, notifies the information processing apparatus of the wireless communication; a radio field intensity transfer section that, according to a request from the information processing apparatus for transfer of the radio field intensity, transfers the radio field intensity held in the radio field intensity holding section to the information processing apparatus; a device control program holding section that holds a device control program for the information processing apparatus to control the device via the communication section; a device control program transfer section that, according to a request from the information processing apparatus for transfer of the device control program, transfers the device control program held in the device control program holding section to the information processing apparatus; the information processing apparatus includes a device search section that searches out a device connected through the communication section; a connection style identification section that identifies the style of the connection with the communication section of the device searched out by the device search section; a radio field intensity acquisition section that, from a device for which the connection style is identified to be wireless communication by the connection style identification section, acquires the radio field intensity for wireless communication of the device; a device selection section that, according to the radio field intensity acquired by the radio field intensity acquisition section, selects a device; a device control software acquisition section which, from the device selected by the device selection section, acquires the device control program; and a device control program setting section that sets the device control program acquired by the device control program acquisition section so as to be available, whereby devices connected by the wireless communication can be easily utilized.

### Third Exemplary Embodiment

In a third exemplary embodiment, an example will be described in which the information processing apparatus program (hereinafter referred to as the “printer driver acquisition program”) pertaining to the present invention installed in the PC 2 identifies a wireless printer with which wireless communication are to be performed, on the basis of whether there is a radio field intensity for wireless communication, and acquires the printer driver from the wireless printer.

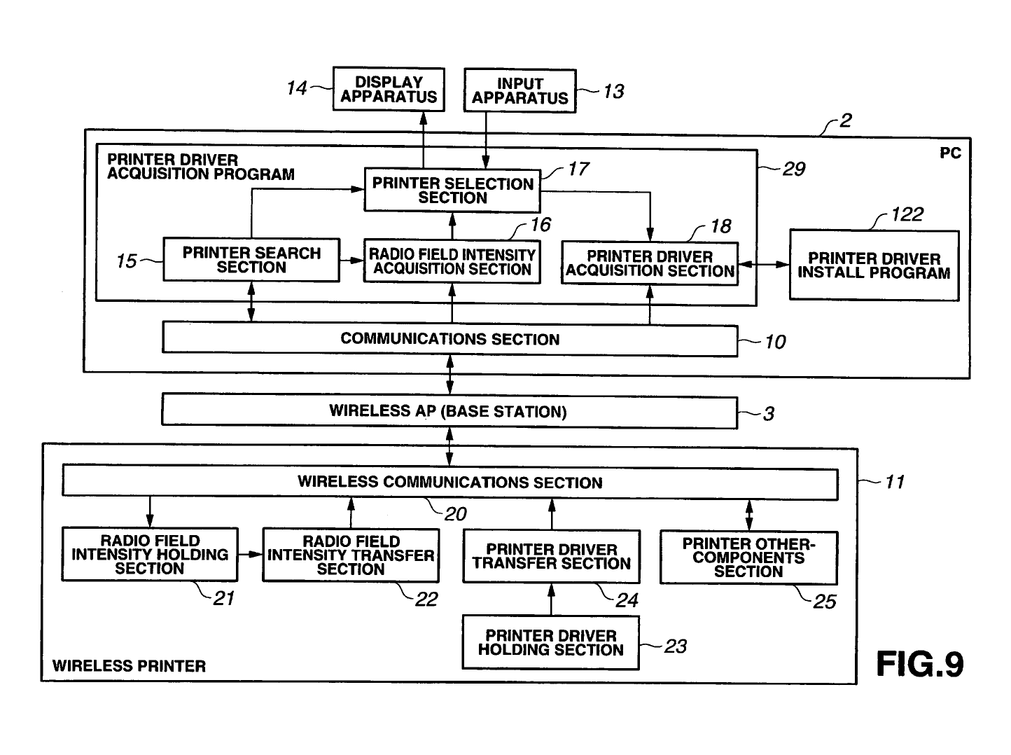

FIG. 9 is a block diagram illustrating an example of a functional configuration of the PC 2 and the wireless printer 11.

First, the functional configuration of the PC 2 will be described.

As shown in FIG. 9, a printer driver acquisition program 29, a printer driver install program 122, and various types of application software (not shown) for realizing application programs are installed in the PC 2, and these utilize the functions of the OS (not shown) for implementing various types of process under the control of the OS. In addition, input apparatuses 13 such as a keyboard and a mouse, and a display apparatus 14 such as a display are connected to the PC 2. The components other than the above-described components of the PC 2 are not shown, and thus description thereof is omitted.

Next, the functional configuration of the printer driver acquisition program 29 will be described.

As shown in FIG. 9, the printer driver acquisition program 29 includes a printer search section 15, a radio field intensity acquisition section 16, a printer selection section 17, and a printer driver acquisition section 18 as the functions thereof.

The printer search section 15 searches out a printer connected to the PC 2 regardless of whether the connection is wired or wireless.

The radio field intensity acquisition section 16 acquires the radio field intensity (or the communication level) for wireless communication from the printer searched out by the printer search section 15. Herein, the radio field intensity cannot be acquired from a printer which does not perform wireless communication, in other words, that of wired connection, thus a printer from which the radio field intensity cannot be acquired is regarded as that of wired connection at this point of time, and the printer driver acquisition program 29 does not acquire the printer driver from the printer which is regarded as a printer of wired connection.

The printer selection section 17 compares the radio field intensity acquired from the wireless printer 11 with a prescribed value (hereinafter referred to as a “threshold value”) to select and enter into a list (hereinafter referred to as a “printers list”) the wireless printer 11 having a radio field intensity higher than the threshold value as the wireless printer 11 of which printer driver is to be acquired. The user can set the threshold value.

The printer driver acquisition section 18 acquires the printer driver from the wireless printer 11 in the list of the printers selected by the printer selection section 17. There may be two cases to acquire the printer driver: the first case is that the printer driver may be acquired from all the wireless printers 11 in the printers list selected by the printer selection section 17; and, the second case is that the printer driver may be acquired from the wireless printer 11 selected by the user in a way that the wireless printers in the printers list selected by the printer selection section 17 are displayed on the display device 14, and using the input device 13, the user selects from the printers list displayed on the display device 14 the wireless printer 11 of which the printer driver is to be acquired.

The functional configuration of the wireless printer 11 is the same as that of the wireless printer 11 as described in the first and the second exemplary embodiments, thus description thereof is omitted herein.

Next, the operation of the printer driver acquisition program 29 and that of the wireless printer 11 will be described.

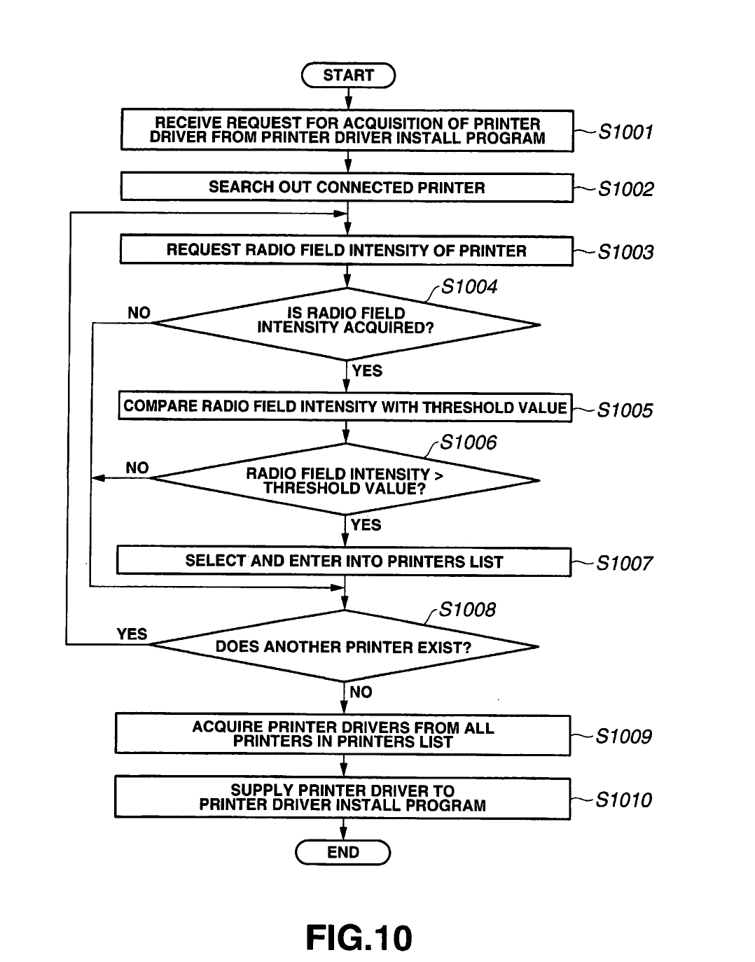

FIG. 10 is a flowchart illustrating the flow of operation of the printer driver acquisition program in a case where the printer driver is to be acquired from all the wireless printers in the printers list, respectively.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When a request for acquisition of the printer driver is received from the printer driver install program which is activated (S1001), the printer search section searches out a printer connected to the PC regardless of whether the connection is wired or wireless (S1002); the radio field intensity acquisition section requests the radio field intensity of the searched-out printer (S1003); and in a case where the radio field intensity is acquired (YES at S1004), the system proceeds to S1005, while, in a case where the radio field intensity cannot be acquired (NO at S1004), the system proceeds to S1008.

In a case where the radio field intensity is acquired (YES at S1004), the printer selection section compares the acquired radio field intensity with the threshold value (S1005), and in a case where the radio field intensity is higher than the threshold value (YES at S1006), the system proceeds to S1007, while, in a case where the radio field intensity is lower than the threshold value (NO at S1006), the system proceeds to S1008.

In a case where the radio field intensity is higher than the threshold value (YES at S1006), the printer selection section selects the printer having the radio field intensity to enter it into the printers list (S1007), the system proceeding to S1008.

And, in a case where another printer exists (YES at S1008), the system returns to S1003, while, in a case where no other printer exists (NO at S1008), the system proceeds to S1009.

In a case where no other printer exists (NO at S1008), the printer driver acquisition section acquires the printer driver from all the printers in the printers list (S1009), and the printer driver acquisition section supplies the acquired printer driver to the printer driver install program (S1010), the system terminating the acquisition process.

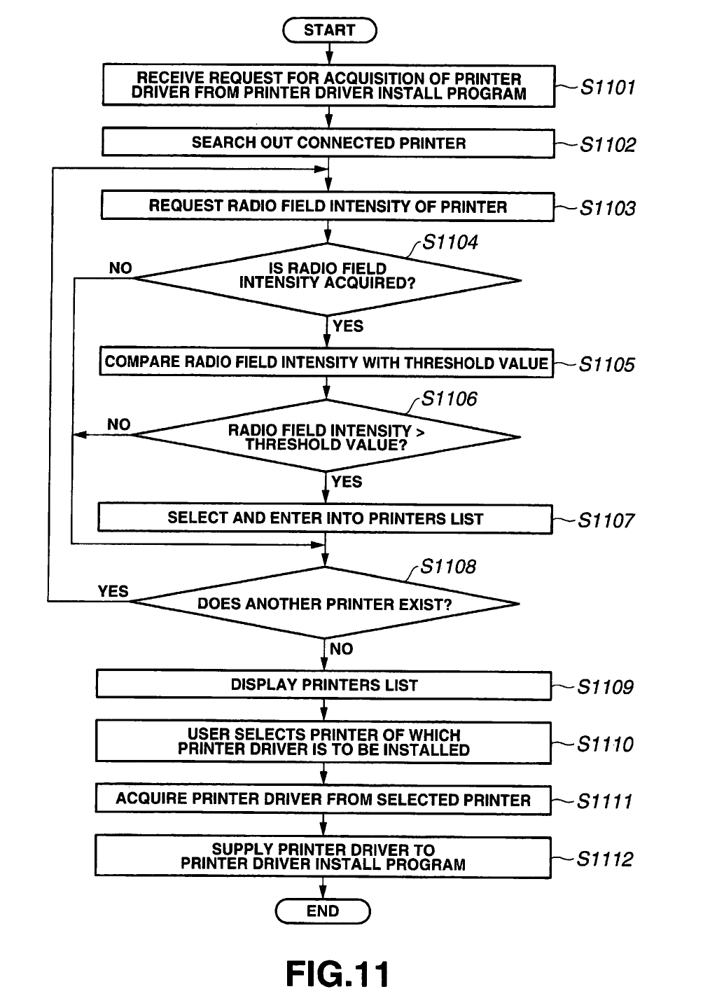

FIG. 11 is a flowchart illustrating the flow of operation of the printer driver acquisition program in a case where the printer driver is to be acquired from the wireless printer selected from the printers list by the user.

The printer driver install program is generally activated by the user instruction (for example, an instruction given by clicking the icon representing the printer driver install program displayed on the desktop of the PC, an instruction given by clicking the printing pushbutton prepared by an application program during data processing carried out thereby, or the like), however, in a case where the printer driver install program is a resident program, the install program may be activated at the time of system start-up.

When a request for acquisition of the printer driver is received from the printer driver install program which is activated (S1101), the printer search section searches out a printer connected to the PC regardless of whether the connection is wired or wireless (S1102); the radio field intensity acquisition section requests the radio field intensity of the searched-out printer (S1103); and in a case where the radio field intensity is acquired (YES at S1104), the system proceeds to S1105, while, in a case where the radio field intensity cannot be acquired (NO at S1104), the system proceeds to S1108.

In a case where the radio field intensity is acquired (YES at S1104), the printer selection section compares the acquired radio field intensity with the threshold value (S1105), and in a case where the radio field intensity is higher than the threshold value (YES at S1106), the system proceeds to S1107, while, in a case where the radio field intensity is lower than the threshold value (NO at S1106), the system proceeds to S1108.

In a case where the radio field intensity is higher than the threshold value (YES at S106), the printer selection section selects the printer having the radio field intensity to enter it into the printers list (S1107), the system proceeding to S1108.

And, in a case where another printer exists (YES at S1108), the system returns to S1103, while, in a case where no other printer exists (NO at S1108), the system proceeds to S1009.

In a case where no other printer exists (NO at S1108), a printers list is displayed on the display apparatus (S1109). The printers list is displayed on, for example, the screen 26 as shown in FIG. 5.

And, the user selects the printer of which printer driver is to be installed (S1110); the printer driver acquisition section acquires the printer driver from the selected printer (S1111); and the printer driver acquisition section supplies the acquired printer driver to the printer driver install program (S1112), the system terminating the acquisition process.

The printer driver acquisition program can be supplied by storing on a storage medium, such as various memories and optical disks, and can also be distributed through a communication line.

### Fourth Exemplary Embodiment

In a fourth exemplary embodiment, an example will be described in which the information processing apparatus program (hereinafter referred to as the “printer driver acquisition program”) pertaining to the present invention that is installed in the PC 2 identifies a wireless printer with which wireless communication are to be performed, by identifying the connection style of the printer to be connected, and acquires the printer driver from the wireless printer to install the printer driver into the PC2.

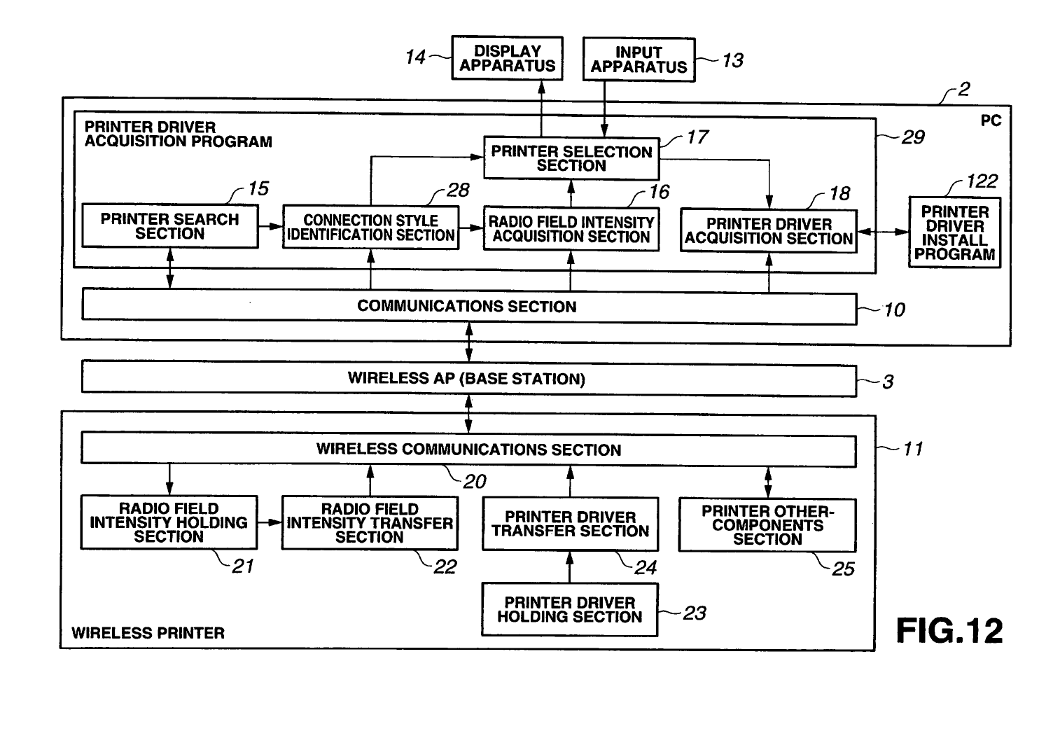

FIG. 12 is a block diagram illustrating an example of the functional configuration of the PC 2 and the wireless printer 11.

First, the functional configuration of the PC 2 will be described.

As shown in FIG. 12, a printer driver acquisition program 29, a printer driver install program 122, and various types of application software (not shown) for realizing application programs are installed in the PC 2, and these utilize the functions of the OS (not shown) for implementing various types of process under the control of the OS. In addition, input apparatuses 13, such as a keyboard and a mouse, and a display apparatus 14, such as a display are connected to the PC 2. The components other than the above-described components of the PC 2 are not shown, and thus description thereof is omitted.

Next, the functional configuration of the printer driver acquisition program 29 will be described.

As shown in FIG. 12, the printer driver acquisition program 29 includes a printer search section 15, a connection style identification section 28, a radio field intensity acquisition section 16, a printer selection section 17, and a printer driver acquisition section 18 as the functions thereof.

The printer search section 15 searches out a printer connected to the PC 2 regardless of whether the connection is wired or wireless.

The connection style identification section 28 identifies the connection style of the printer searched out by the printer search section 15 (in other words, whether the connection is wireless or wired). Herein, the printer driver acquisition program 29 does not acquire the printer driver from the printer of which connection style is identified to be wired.

The radio field intensity acquisition section 16 acquires the radio field intensity (or the communication level) for wireless communication from the wireless printer 11 of which connection style is identified to be wireless by the connection style identification section 28.

The printer selection section 17 compares the radio field intensity acquired from the wireless printer 11 with a prescribed value (hereinafter referred to as a “threshold value”) to select and enter into a list (hereinafter referred to as a “printers list”) the wireless printer 11 having a radio field intensity higher than the threshold value as the wireless printer 11 of which printer driver is to be acquired. The user can set the threshold value.

The printer driver acquisition section 18 acquires the printer driver from the wireless printer 11 in the list of the printers selected by the printer selection section 17. There may be two cases to acquire the printer driver: the first case is that the printer driver may be acquired from all the wireless printers 11 in the printers list selected by the printer selection section 17; and, the second case is that the printer driver may be acquired from the wireless printer 11 selected by the user in a way that the wireless printers in the printers list selected by the printer selection section 17 are displayed on the display device 14, and using the input device 13, the user selects from the printers list displayed on the display device 14 the wireless printer 11 of which the printer driver is to be acquired.

The functional configuration of the wireless printer 11 is the same as that of the wireless printer 11 as described in the first, the second and the third exemplary embodiments, thus description thereof is omitted herein.

Next, the operation of the printer driver acquisition program 29 and that of the wireless printer 11 will be described.

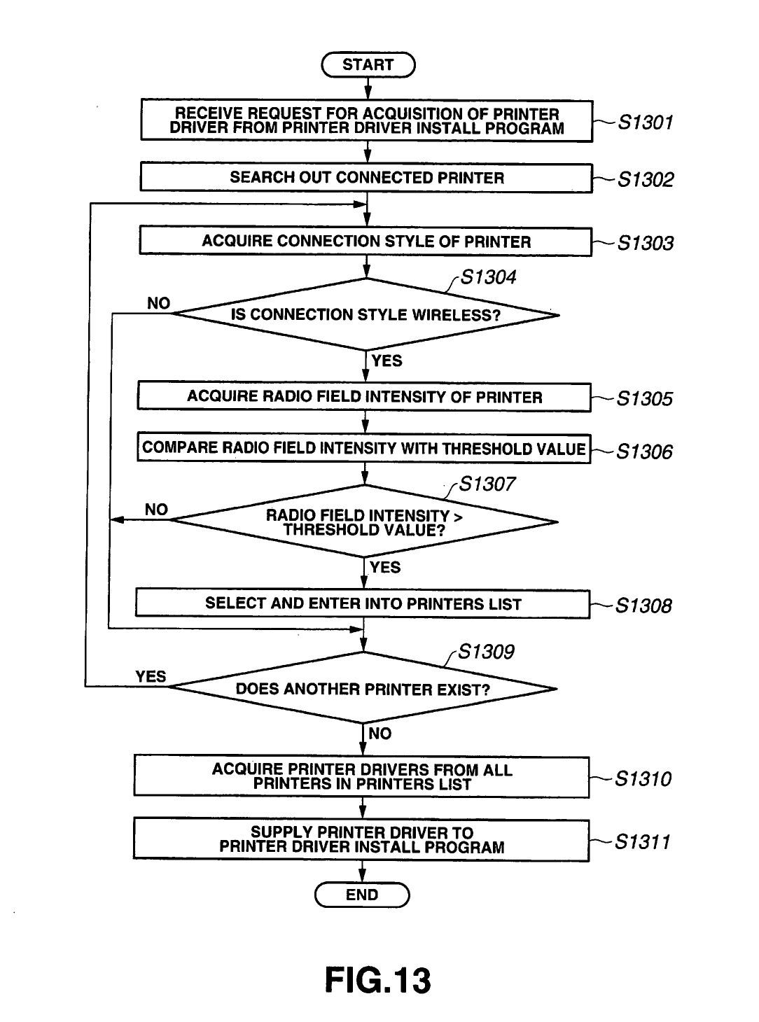

FIG. 13 is a flowchart illustrating the flow of operation of the printer driver acquisition program in a case where the printer driver is to be acquired from all the wireless printers in the printers list.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When a request for acquisition of the printer driver is received from the printer driver install program which is activated (S1301), the printer search section searches out a printer connected to the PC regardless of whether the connection is wired or wireless (S1302); the connection style identification section acquires the connection style from the searched-out printer (S1303); in a case where the connection style is identified to be wireless (YES at S1304), the system proceeds to S1305, while, in a case where the connection style is identified to be wired (NO at S1304), the system proceeds to S1309.

In a case where the connection style is identified to be wireless (YES at S1304), the radio field intensity acquisition section requests the radio field intensity of the printer identified to be wireless (S1305); the printer selection section compares the acquired radio field intensity with the threshold value (S1306); in a case where the radio field intensity is higher than the threshold value (YES at S1307), the system proceeds to S1308, while, in a case where the radio field intensity is lower than the threshold value (NO at S1307), the system proceeds to S1309.

In a case where the radio field intensity is higher than the threshold value (YES at S1307), the printer selection section selects the printer having the radio field intensity to enter it into the printers list (S1308), the system proceeding to S1309.

And, in a case where another printer exists (YES at S1309), the system returns to S1303, while, in a case where no other printer exists (NO at S1309), the system proceeds to S1310.

In a case where no other printer exists (NO at S1309), the printer driver acquisition section acquires the printer driver from all the printers in the printers list (S1310), and the printer driver acquisition section supplies the acquired printer driver to the printer driver install program (S1311), the system terminating the acquisition process.

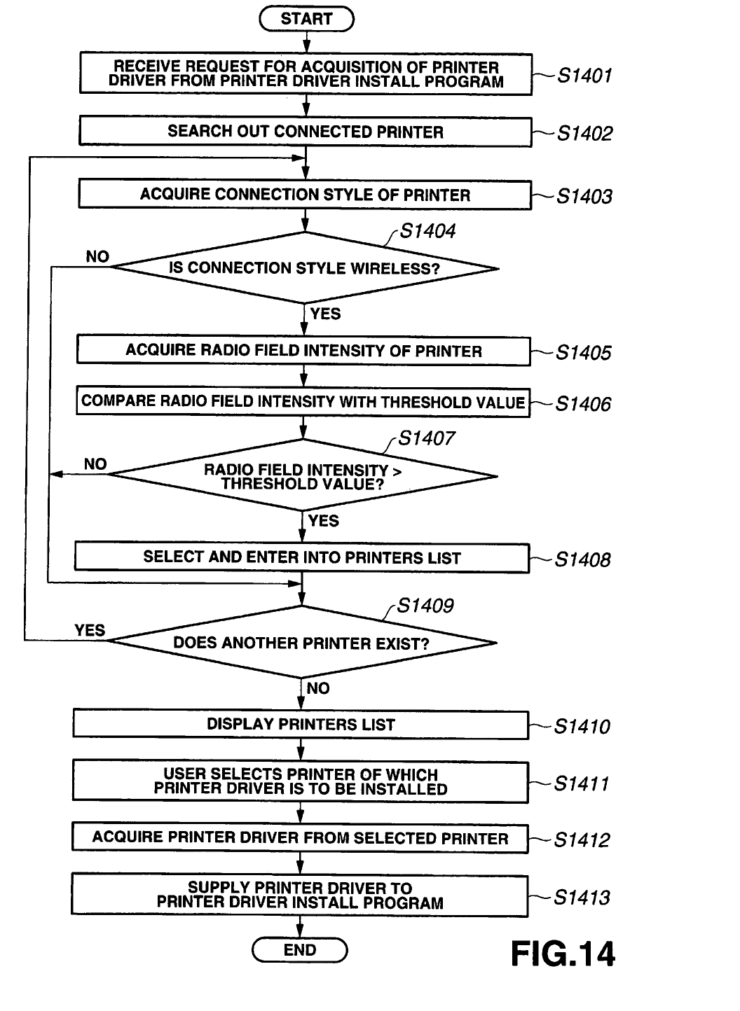

FIG. 14 is a flowchart illustrating the flow of operation of the printer driver acquisition program in a case where the printer driver is to be acquired from the wireless printer selected from the printers list by the user.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When a request for acquisition of the printer driver is received from the printer driver install program which is activated (S1401), the printer search section searches out a printer connected to the PC regardless of whether the connection is wired or wireless (S1402); the connection style identification section acquires the connection style from the searched-out printer (S1403); in a case where the connection style is identified to be wireless (YES at S1404), the system proceeds to S1405, while, in a case where the connection style is identified to be wired (NO at S1404), the system proceeds to S1409.

In a case where the connection style is identified to be wireless (YES at S1404), the radio field intensity acquisition section requests the radio field intensity of the printer which is identified to be wireless (S1405); the printer selection section compares the acquired radio field intensity with the threshold value (S1406); in a case where the radio field intensity is higher than the threshold value (YES at S1407), the system proceeds to S1408, while, in a case where the radio field intensity is lower than the threshold value (NO at S1407), the system proceeds to S1409.

In a case where the radio field intensity is higher than the threshold value (YES at S1407), the printer selection section selects the printer having the radio field intensity to enter it into the printers list (S1408), the system proceeding to S1409.

And, in a case where another printer exists (YES at S1409), the system returns to S1403, while, in a case where no other printer exists (NO at S1409), the system proceeds to S1410.

In a case where no other printer exists (NO at S1409), a printers list is displayed on the display apparatus (S1410). The printers list is displayed on, for example, the screen 26 as shown in FIG. 5.

And, the user selects the printer of which printer driver is to be installed (S1411); the printer driver acquisition section acquires the printer driver from the selected printer (S1412); and the printer driver acquisition section supplies the acquired printer driver to the printer driver install program (S1413), the system terminating the acquisition process.

The printer driver acquisition program can be supplied by storing on storage media, such as various memories and optical disks, and can also be distributed through a communication line.

An information processing apparatus program, which causes an information processing apparatus to implement processes, includes: an acquisition request reception process that, from a device control program setting program that sets the device control program for controlling a device connected through a communication section, via the communication section, so as to be available, receives an acquisition request for the device control program; a device search process that searches out a device connected through the communication section; a connection style identification process that identifies the style of the connection with the communication section of the device searched out by the device search process; a radio field intensity acquisition process that, from a device for which the connection style is identified to be wireless communication by the connection style identification process, acquires the radio field intensity for wireless communication of the device; a device selection process that, according to the radio field intensity acquired by the radio field intensity acquisition process, selects a device; a device control software acquisition process that acquires the device control program for the device selected by the device selection process; and a device control program supply process that supplies the device control program acquired by the device control program acquisition process to the device control program setting program, whereby it is made possible to easily utilize devices which are connected by wireless communication.

### Fifth Exemplary Embodiment

In a fifth exemplary embodiment, an example will be described in which the information processing apparatus program (hereinafter referred to as the “printer driver install program”) pertaining to the present invention that is installed in the PC 2 identifies a wireless printer with which wireless communication are to be performed on the basis of whether there is a radio field intensity for wireless communication, and reads out the printer driver for the wireless printer from a storage medium (for example, a memory, an optical disk) which is set in the PC 2 and which holds the printer drivers for each of the printers, or acquires the printer driver for the wireless printer from the printer driver storage apparatus which is connected to the communication system 1 and which holds the printer drivers for each of the printers, in order to install the printer driver to the PC 2.

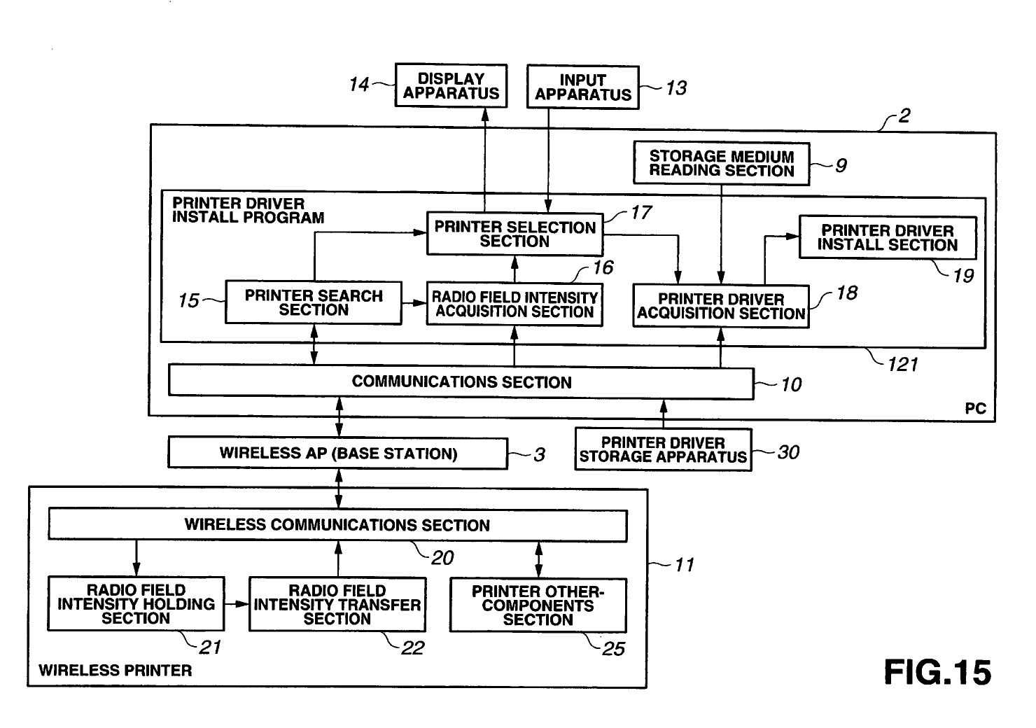

FIG. 15 is a block diagram illustrating an example of the functional configuration of the PC 2 and the wireless printer 11.

First, the functional configuration of the PC 2 will be described.

As shown in FIG. 15, a printer driver install program 121 and various types of application software (not shown) for realizing application programs are installed in the PC 2, and these utilize the functions of the OS (not shown) for implementing various types of process under the control of the OS. In addition, input apparatuses 13, such as a keyboard and a mouse, and a display apparatus 14, such as a display, are connected to the PC 2. The components other than the above-described components of the PC 2 are not shown, and thus description thereof is omitted.

Next, the functional configuration of the printer driver install program 121 will be described.

As shown in FIG. 15, the printer driver install program 121 includes a printer search section 15, a radio field intensity acquisition section 16, a printer selection section 17, a printer driver acquisition section 18, and a printer driver install section 19 as the functions thereof.

The printer search section 15 performs a process of searching out a printer connected to the PC 2 regardless of whether the connection is wired or wireless.

The radio field intensity acquisition section 16 acquires the radio field intensity (or the communication level) for wireless communication from the printer searched out by the printer search section 15. Herein, from a printer which will not perform wireless communication, in other words, that of wired connection, the radio field intensity cannot be acquired, thus a printer from which the radio field intensity cannot be acquired is regarded as that of wired connection at this point of time, and the printer driver install program 121 will not acquire the printer driver from the printer which is regarded as a printer of wired connection.

The printer selection section 17 compares the radio field intensity acquired from the wireless printer 11 with a prescribed value (hereinafter referred to as a “threshold value”) to select and enter into a list (hereinafter referred to as a “printers list”) the wireless printer 11 having a radio field intensity higher than the threshold value as the wireless printer 11 of which printer driver is to be installed. The user can set the threshold value.

The printer driver acquisition section 18 acquires the printer driver for the wireless printer 11 in the printers list which is selected by the printer selection section 17, from the storage medium reading section 9 or the printer driver storage apparatus 30. In a case where the printer driver is to be acquired from the storage medium reading section 9, the storage medium reading section 9 reads out only the printer driver for the wireless printer in the printers list from the storage medium set in the PC 2, and the printer driver acquisition section 18 acquires the read-out printer driver. On the other hand, in a case where the printer driver is acquired from the printer driver storage apparatus 30, the printer driver acquisition section 18 accesses the printer driver storage apparatus 30 through the communication section 10, and acquires only the printer driver for the wireless printer in the printers list. In addition, there may be two cases to acquire the printer driver: the first case is that the printer driver may be acquired from all the wireless printers 11 in the printers list selected by the printer selection section 17; and, the second case is that the printer driver may be acquired from the wireless printer 11 selected by the user in a way that the wireless printers in the printers list selected by the printer selection section 17 are displayed on the display device 14, and using the input device 13, the user selects from the printers list displayed on the display device 14 the wireless printer 11 of which the printer driver is to be installed.

The printer driver install section 19 installs the printer driver acquired by the printer driver acquisition section 18 into the PC 2.

Next, the functional configuration of the wireless printer 11 will be described.

As shown in FIG. 15, the wireless printer 11 includes a wireless communication section 20, a radio field intensity holding section 21, a radio field intensity transfer section 22, and a printer other-components section 25.

The wireless communication section 20 performs wireless communication with the wireless AP 3 and the like, and includes an antenna, transmission and reception circuits, a measuring circuit for radio field intensity, and the like. For radio field intensity, utilization of the RSSI (Received Signal Strength Indication, which is a numerical indication of the intensity of a radio wave signal being received) or the S/N ratio (Signal to Noise Ratio) which is generally held by a wireless communication apparatus as surrounding information for carrying out range division on the basis of the measurement of the radio field intensity is known as a well-known technology.

The radio field intensity holding section 21 is a storage region for holding the radio field intensity measured by the wireless communication section 20.

The radio field intensity transfer section 22 transfers the radio field intensity held in the radio field intensity holding section 21 to the PC 2 when a radio field intensity request is received from the PC 2 (in other words, the printer driver install program 121).

The printer other-components section 25 is a general components section constituting the wireless printer 11.

The holding of the radio field intensity by the wireless printer 11 and the transferring of the radio field intensity from the wireless printer 11 to the PC 2 are carried out by taking the procedure of, for example, that the wireless printer 11 holds the radio field intensity as the MIB (Management Information Base); the printer driver install program 121 requests the radio field intensity of the wireless printer 11 under the SNMP (Simple Network Management Protocol); and the wireless printer 11 acquires the radio field intensity from the MIB, and notifies the printer driver install program 121 of the contents thereof.

Next, the operation of the printer driver install program 121 and that of the wireless printer 11 will be described.

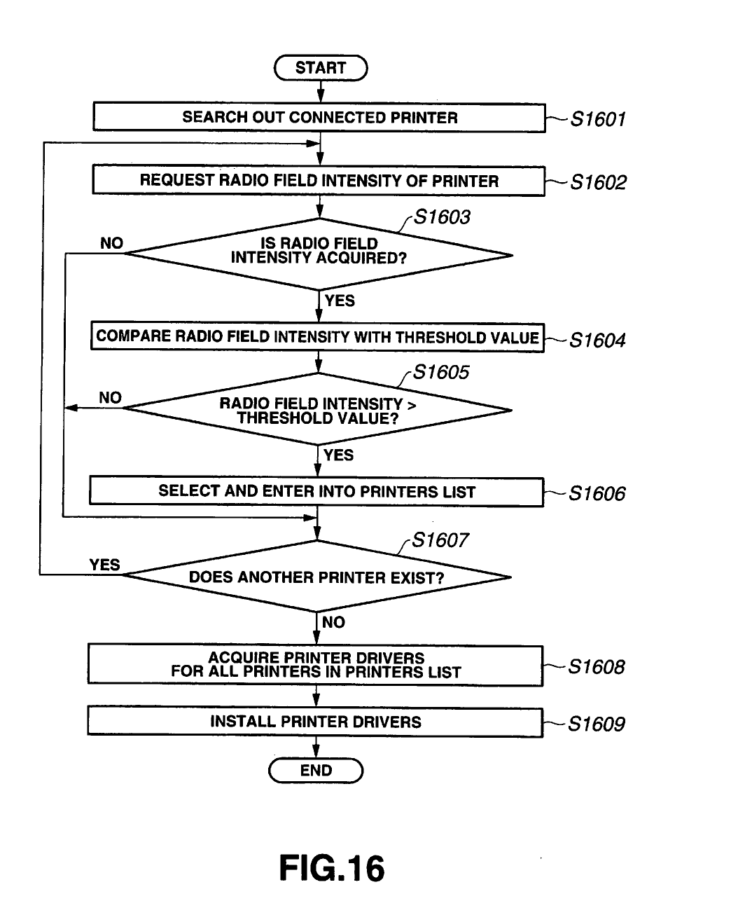

FIG. 16 is a flowchart illustrating the flow of operation of the printer driver install program in a case where the printer drivers for all the wireless printers in the printers list are to be acquired.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When the printer driver install program is activated, the printer search section searches out a printer connected to the PC regardless of whether the connection is wired or wireless (S1601); the radio field intensity acquisition section requests the radio field intensity of the searched-out printer (S1602); and in a case where the radio field intensity is acquired (YES at S1603), the system proceeds to S1604, while, in a case where the radio field intensity cannot be acquired (NO at S1603), the system proceeds to S1607.

In a case where the radio field intensity is acquired (YES at S1603), the printer selection section compares the acquired radio field intensity with the threshold value (S1604), and in a case where the radio field intensity is higher than the threshold value (YES at S1605), the system proceeds to S1606, while, in a case where the radio field intensity is lower than the threshold value (NO at S1605), the system proceeds to S1607.

In a case where the radio field intensity is higher than the threshold value (YES at S1605), the printer selection section selects the printer having the radio field intensity to enter it into the printers list (S1606), the system proceeding to S1607.

And, in a case where another printer exists (YES at S1607), the system returns to S1602, while, in a case where no other printer exists (NO at S1607), the system proceeds to S1608.

In a case where no other printer exists (NO at S1607), the printer driver acquisition section acquires the respective printer drivers for all the printers in the printers list from the storage medium or the printer driver storage apparatus (S1608), and the printer driver install section implements installation of the acquired printer drivers (S1609), the system terminating the installation process.

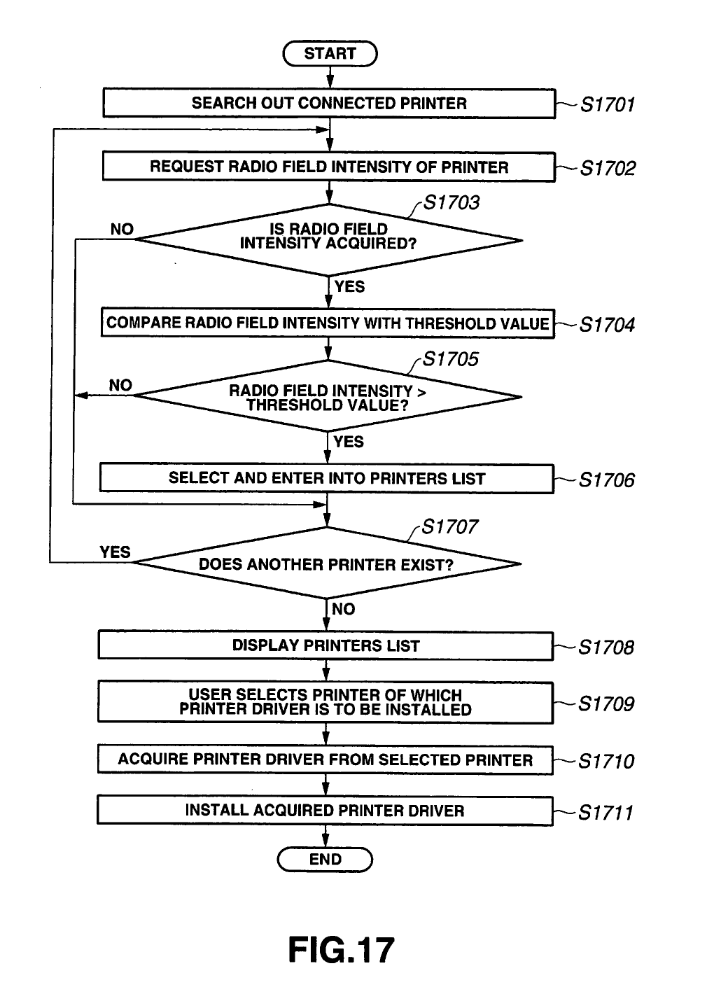

FIG. 17 is a flowchart illustrating the flow of operation of the printer driver install program in a case where the printer driver for the wireless printer selected from the printers list by the user is to be acquired.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When the printer driver install program is activated, the printer search section searches out a printer connected to the PC regardless of whether the connection is wired or wireless (S1701); the radio field intensity acquisition section requests the radio field intensity of the searched-out printer (S1702); and in a case where the radio field intensity is acquired (YES at S1703), the system proceeds to S1704, while, in a case where the radio field intensity cannot be acquired (NO at S1703), the system proceeds to S1707.

In a case where the radio field intensity is acquired (YES at S1703), the printer selection section compares the acquired radio field intensity with the threshold value (S1704), and in a case where the radio field intensity is higher than the threshold value (YES at S1705), the system proceeds to S1706, while, in a case where the radio field intensity is lower than the threshold value (NO at S1705), the system proceeds to S707.

In a case where the radio field intensity is higher than the threshold value (YES at S1705), the printer selection section selects the printer having the radio field intensity to enter it into the printers list (S1706), the system proceeding to S1707.

And, in a case where another printer exists (YES at S1707), the system returns to S1702, while, in a case where no other printer exists (NO at S1707), the system proceeds to S1708.

In a case where no other printer exists (NO at S1707), a printers list is displayed on the display apparatus (S1708). The printers list is displayed on, for example, the screen 26 as shown in FIG. 5.

And, the user selects the printer of which printer driver is to be installed (S1709); the printer driver acquisition section acquires the printer driver for the selected printer from the storage medium or the printer driver storage apparatus (S1710); and the printer driver install section implements installation of the acquired printer driver (S1711), the system terminating the installation process.

The printer driver install program can be supplied by storing on storage media, such as various memories, optical disks, and the like, and can also be distributed through a communication line.

### Sixth Exemplary Embodiment

In a sixth exemplary embodiment, an example will be described in which the information processing apparatus program (hereinafter referred to as the “printer driver install program”) pertaining to the present invention that is installed in the PC 2 identifies a wireless printer with which wireless communication are to be performed by identifying the connection style of the printer to be connected, and reads out the printer driver for the wireless printer from a storage medium (for example, a memory, an optical disk, or the like) which is set in the PC 2 and which holds the printer drivers for each of the respective printers, or acquires the printer driver for the wireless printer from the printer driver storage apparatus connected to the communication system 1 and which holds the printer drivers for each of the respective printers in order to install the printer driver into the PC2.

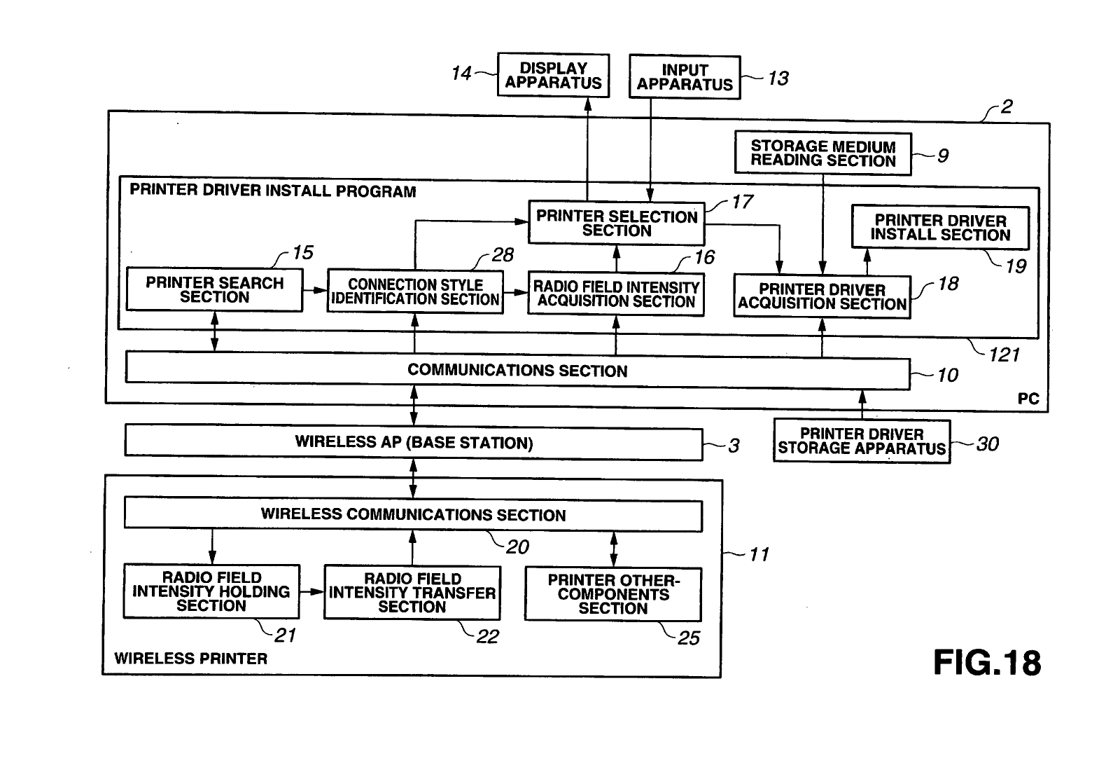

FIG. 18 is a block diagram illustrating an example of the functional configuration of the PC 2 and the wireless printer 11.

First, the functional configuration of the PC 2 will be described.

As shown in FIG. 18, a printer driver install program 121 and various types of application software (not shown) for realizing application programs are installed in the PC 2, and these utilize the functions of the OS (not shown) for implementing various types of process under the control of the OS. In addition, input apparatuses 13, such as a keyboard and a mouse, and a display apparatus 14, such as a display, are connected to the PC 2. The components other than the above-described components of the PC 2 are not shown, and thus description thereof is omitted.

Next, the functional configuration of the printer driver install program 121 will be described.

As shown in FIG. 18, the printer driver install program 121 includes a printer search section 15, a connection style identification section 28, a radio field intensity acquisition section 16, a printer selection section 17, a printer driver acquisition section 18, and a printer driver install section 19 as the functions thereof.

The printer search section 15 searches out a printer connected to the PC 2 regardless of whether the connection is wired or wireless.

The connection style identification section 28 identifies the connection style of the printer searched out by the printer search section 15 (in other words, whether the connection is wireless or wired). Herein, the printer driver install program 121 does not acquire the printer driver from the printer of which connection style is identified to be wired.

The radio field intensity acquisition section 16 acquires the radio field intensity (or the communication level) for wireless communication from the wireless printer 11 of which connection style is identified to be wireless by the connection style identification section 28.

The printer selection section 17 compare the radio field intensity acquired from the wireless printer 11 with a prescribed value (hereinafter referred to as a “threshold value”) to select and enter into a list (hereinafter referred to as a “printers list”) the wireless printer 11 having a radio field intensity higher than the threshold value as the wireless printer 11 of which printer driver is to be installed. The user can set the threshold value.

The printer driver acquisition section 18 acquires the printer driver for the wireless printer 11 in the printers list which is selected by the printer selection section 17, from the storage medium reading section 9 or the printer driver storage apparatus 30. In a case where the printer driver is to be acquired from the storage medium reading section 9, the storage medium reading section 9 reads out only the printer driver for the wireless printer in the printers list from the storage medium set in the PC 2, and the printer driver acquisition section 18 acquires the read-out printer driver. On the other hand, in a case where the printer driver is acquired from the printer driver storage apparatus 30, the printer driver acquisition section 18 accesses the printer driver storage apparatus 30 through the communication section 10, and acquires only the printer driver for the wireless printer in the printers list. In addition, there may be two cases to acquire the printer driver: the first case is that the printer driver may be acquired from all the wireless printers 11 in the printers list selected by the printer selection section 17; and, the second case is that the printer driver may be acquired from the wireless printer 11 selected by the user in a way that the wireless printers in the printers list selected by the printer selection section 17 are displayed on the display device 14, and using the input device 13, the user selects from the printers list displayed on the display device 14 the wireless printer 11 of which the printer driver is to be installed.

The printer driver install section 19 installs the printer driver acquired by the printer driver acquisition section 18 into the PC 2.

The functional configuration of the wireless printer 11 is the same as that of the wireless printer 11 as described in the fifth exemplary embodiment, thus description thereof is omitted herein.

Next, the operation of the printer driver install program 121 and that of the wireless printer 11 will be described.

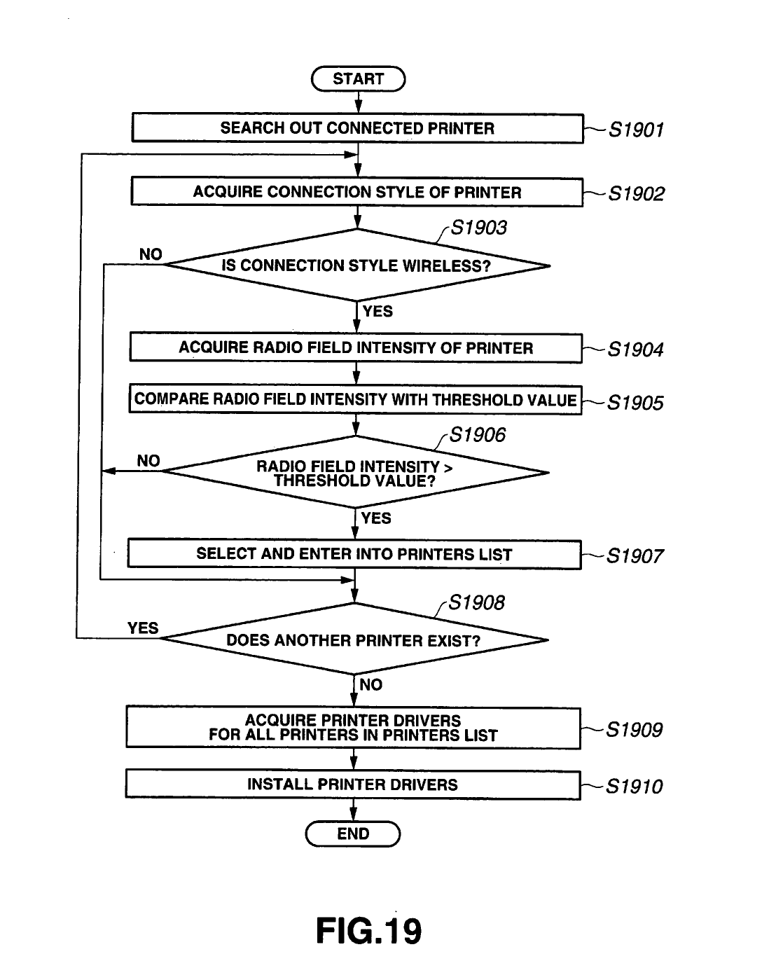

FIG. 19 is a flowchart illustrating the flow of operation of the printer driver install program in a case where each of the printer drivers for all the wireless printers in the printers list are to be acquired.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When the printer driver install program is activated, the printer search section searches out a printer connected to the PC regardless of whether the connection is wired or wireless (S1901); the printer search section acquires the connection style from the searched-out printer (S1902); and in a case where the connection style is identified to be wireless (YES at S1903), the system proceeds to S1904, while, in a case where the connection style is identified to be wired (NO at S1903), the system proceeds to S1908.

In a case where the connection style is identified to be wireless (YES at S1903), the radio field intensity acquisition section requests the radio field intensity of the printer identified to be wireless (S1904); the printer selection section compares the acquired radio field intensity with the threshold value (S1905); in a case where the radio field intensity is higher than the threshold value (YES at S1906), the system proceeds to S1907, while, in a case where the radio field intensity is lower than the threshold value (NO at S1906), the system proceeds to S1908.

In a case where the radio field intensity is higher than the threshold value (YES at S1906), the printer selection section selects the printer having the radio field intensity to enter it into the printers list (S1907), the system proceeding to S1908.

And, in a case where another printer exists (YES at S1908), the system returns to S1902, while, in a case where no other printer exists (NO at S1908), the system proceeds to S1909.

In a case where no other printer exists (NO at S1908), the printer driver acquisition section acquires the printer drivers for all the printers in the printers list from the storage medium or the printer driver storage apparatus (S1909), and the printer driver install section installs the acquired printer drivers (S1910), the system terminating the installation process.

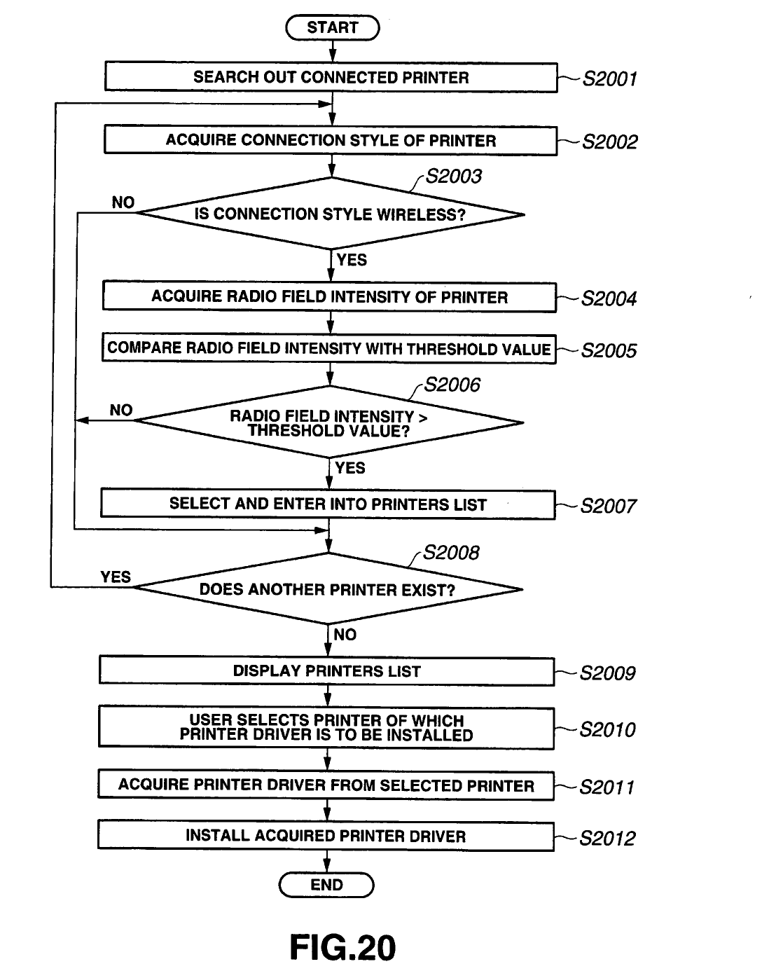

FIG. 20 is a flowchart illustrating the flow of operation of the printer driver install program in a case where the printer driver for the wireless printer selected from the printers list by the user is to be acquired.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When the printer driver install program is activated, the printer search section searches out a printer connected to the PC regardless of whether the connection is wired or wireless (S2001); the printer search section acquires the connection style from the searched-out printer (S2002); and in a case where the connection style is identified to be wireless (YES at S2003), the system proceeds to S2004, while, in a case where the connection style is identified to be wired (NO at S2003), the system proceeds to S2008.

In a case where the connection style is identified to be wireless (YES at S2003), the radio field intensity acquisition section requests the radio field intensity of the printer identified to be wireless (S2004); the printer selection section compares the acquired radio field intensity with the threshold value (S2005); and in a case where the radio field intensity is higher than the threshold value (YES at S2006), the system proceeds to S2007, while, in a case where the radio field intensity is lower than the threshold value (NO at S2006), the system proceeds to S2008.

In a case where the radio field intensity is higher than the threshold value (YES at S2006), the printer selection section selects the printer having the radio field intensity to enter it into the printers list (S2007), the system proceeding to S2008.

And, in a case where another printer exists (YES at S2008), the system returns to S2002, while, in a case where no other printer exists (NO at S2008), the system proceeds to S2009.

In a case where no other printer exists (NO at S2008), a printers list is displayed on the display apparatus (S2009). The printers list is displayed on, for example, the screen 26 as shown in FIG. 5.

And, the user selects the printer of which printer driver is to be installed (S2010); the printer driver acquisition section acquires the printer driver for the selected printer from the storage medium or the printer driver storage apparatus (S2011); and the printer driver install section installs the acquired printer driver (S2012), the system terminating the installation process.

The printer driver install program can be supplied by stored on storage media, such as various memories or optical disks, and can also be distributed through a communication line.

An information processing apparatus includes: a device search section that searches out a device connected through a communication section; a connection style identification section that identifies the style of the connection with the communication section of the device searched out by the device search section; a radio field intensity acquisition section that, from the device for which the connection style is identified to be wireless communication by the connection style identification section, acquires the radio field intensity for wireless communication of the device; a device selection section that, according to the radio field intensity acquired by the radio field intensity acquisition section, selects a device; a device control software acquisition section that acquires the device control program for the device selected by the device selection section; and a device control program setting part that sets the device control program acquired by the device control program acquisition section so as to be available, whereby it is made possible to easily utilize devices connected by wireless communication.

In addition, an information processing apparatus program, which causes an information processing apparatus to implement processes, includes: a device search process that searches out a device connected through a communication section; a connection style identification process that identifies the style of the connection with the communication section of the device searched out by the device search process; a radio field intensity acquisition process that, from a device for which the connection style identified to be wireless communication by the connection style identification process, acquires the radio field intensity for wireless communication of the device; a device selection process that, according to the radio field intensity acquired by the radio field intensity acquisition process, selects a device; a device control software acquisition process that acquires the device control program for the device selected by the device selection process; and a device control program setting process that sets the device control program acquired by the device control program acquisition process so as to be available, whereby it is made possible to easily utilize devices connected by wireless communication.

### Seventh Exemplary Embodiment

In a seventh exemplary embodiment, an example will be described in which the information processing apparatus program (hereinafter referred to as the “printer driver acquisition program”) pertaining to the present invention that is installed in the PC 2 identifies a wireless printer with which wireless communication are to be performed, on the basis of whether there is a radio field intensity for wireless communication, and reads out the printer driver for the wireless printer from the storage medium (for example, a memory, an optical disk, or the like) which is set in the PC 2 and which holds the printer drivers for each of the printers, or acquires the printer driver for the wireless printer from the printer driver storage apparatus which is connected to the communication system 1 and which holds the printer drivers for each of the printers.

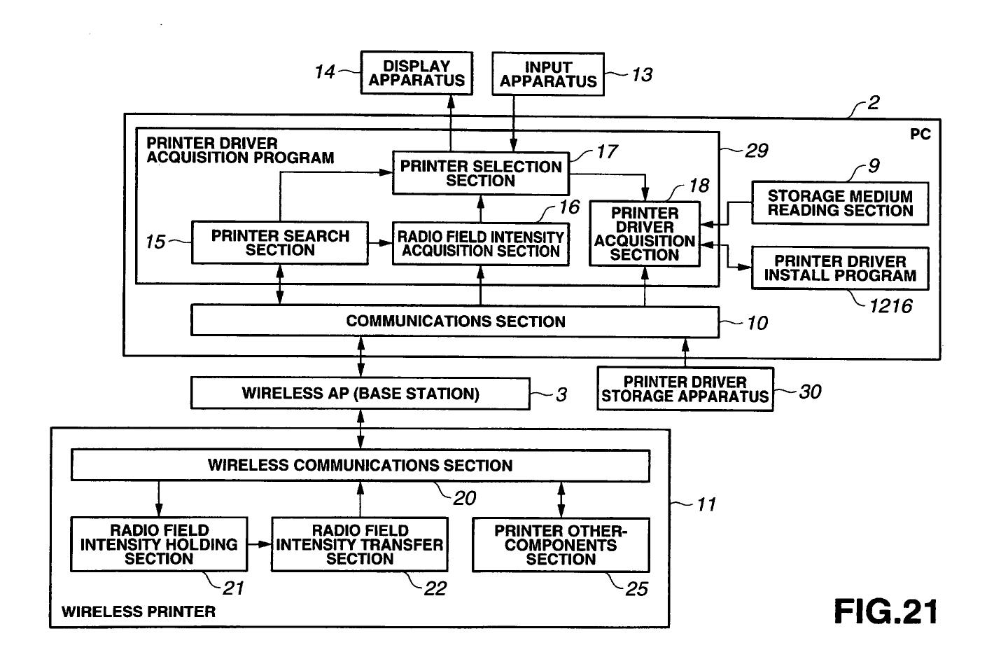

FIG. 21 is a block diagram illustrating an example of the functional configuration of the PC 2 and the wireless printer 11.

First, the functional configuration of the PC 2 will be described.

As shown in FIG. 21, a printer driver acquisition program 29, a printer driver install program 122, and various types of application software (not shown) for realizing application programs are installed in the PC 2, and these utilize the functions of the OS (not shown) for implementing various types of process under the control of the OS. In addition, input apparatuses 13, such as a keyboard and a mouse, and a display apparatus 14, such as a display, are connected to the PC 2. The components other than the above-described components of the PC 2 are not shown, and thus description thereof is omitted.

Next, the functional configuration of the printer driver acquisition program 29 will be described.

As shown in FIG. 21, the printer driver acquisition program 29 includes a printer search section 15, a radio field intensity acquisition section 16, a printer selection section 17, and a printer driver acquisition section 18 as the functions thereof.

The printer search section 15 searches out a printer connected to the PC 2 regardless of whether the connection is wired or wireless.

The radio field intensity acquisition section 16 acquires the radio field intensity (or the communication level) for wireless communication from the printer searched out by the printer search section 15. Herein, from a printer which will not perform wireless communication, in other words, that of wired connection, the radio field intensity cannot be acquired, thus a printer from which the radio field intensity cannot be acquired is regarded as that of wired connection at this point of time, and the printer driver acquisition program 29 will not acquire the printer driver from the printer which is regarded as a printer of wired connection.

The printer selection section 17 compares the radio field intensity acquired from the wireless printer 11 with a prescribed value (hereinafter referred to as a “threshold value”) to select and enter into a list (hereinafter referred to as a “printers list”) the wireless printer 11 having a radio field intensity higher than the threshold value as the wireless printer 11 of which printer driver is to be installed. The user can set the threshold value.

The printer driver acquisition section 18 acquires the printer driver for the wireless printer 11 in the printers list which is selected by the printer selection section 17, from the storage medium reading section 9 or the printer driver storage apparatus 30. In a case where the printer driver is to be acquired from the storage medium reading section 9, the storage medium reading section 9 reads out only the printer driver for the wireless printer in the printers list from the storage medium set in the PC 2, and the printer driver acquisition section 18 acquires the read-out printer driver. On the other hand, in a case where the printer driver is acquired from the printer driver storage apparatus 30, the printer driver acquisition section 18 accesses the printer driver storage apparatus 30 through the communication section 10, and acquires only the printer driver for the wireless printer in the printers list. In addition, there may be two cases to acquire the printer driver: the first case is that the printer driver may be acquired from all the wireless printers 11 in the printers list selected by the printer selection section 17; and, the second case is that the printer driver may be acquired from the wireless printer 11 selected by the user in a way that the wireless printers in the printers list selected by the printer selection section 17 are displayed on the display device 14, and using the input device 13, the user selects from the printers list displayed on the display device 14 the wireless printer 11 of which the printer driver is to be installed.

The functional configuration of the wireless printer 11 is the same as that of the wireless printer 11 as described in the fifth and the sixth exemplary embodiments, thus description thereof is omitted herein.

Next, the operation of the printer driver acquisition program 29 and that of the wireless printer 11 will be described.

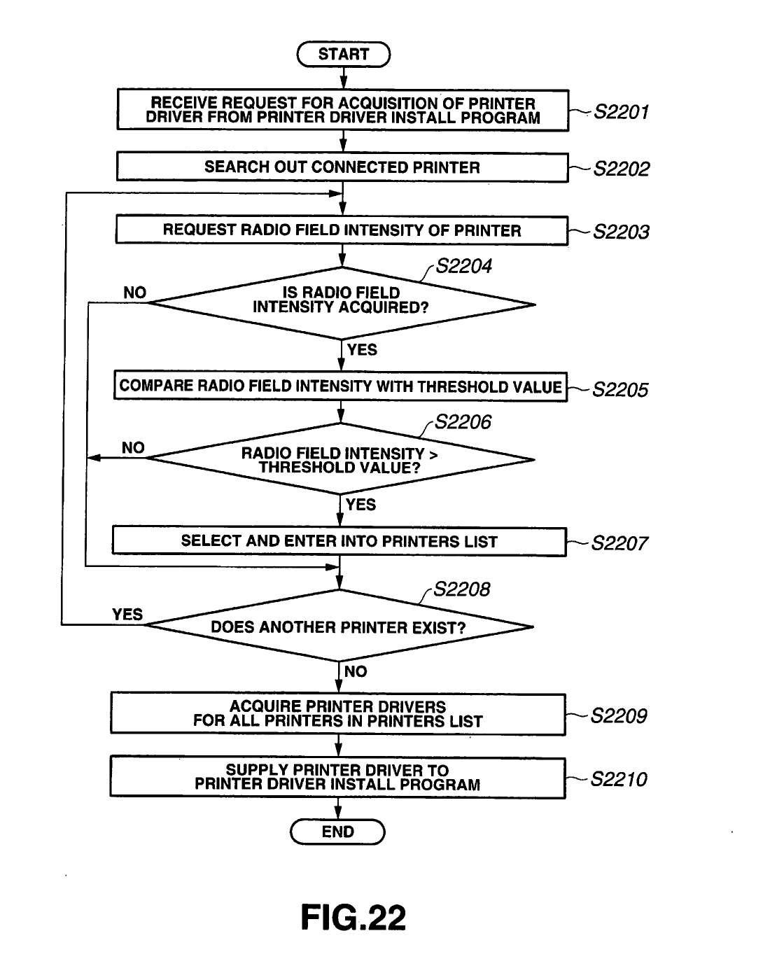

FIG. 22 is a flowchart illustrating the flow of operation of the printer driver acquisition program in a case where the respective printer drivers for all the wireless printers in the printers list are to be acquired.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When a request for acquisition of the printer driver is received from the printer driver install program which is activated (S2201), the printer search section searches out a printer connected to the PC regardless of whether the connection is wired or wireless (S2202); the radio field intensity acquisition section requests the radio field intensity of the searched-out printer (S2203); and in a case where the radio field intensity is acquired (YES at S2204), the system proceeds to S2205, while, in a case where the radio field intensity cannot be acquired (NO at S2204), the system proceeds to S2208.

In a case where the radio field intensity is acquired (YES at S2204), the printer selection section compares the acquired radio field intensity with the threshold value (S2205), and in a case where the radio field intensity is higher than the threshold value (YES at S2206), the system proceeds to S2207, while, in a case where the radio field intensity is lower than the threshold value (NO at S2206), the system proceeds to S2208.

In a case where the radio field intensity is higher than the threshold value (YES at S2206), the printer selection section selects the printer having the radio field intensity to enter it into the printers list (S2207), the system proceeding to S2208.

And, in a case where another printer exists (YES at S2208), the system returns to S2203, while, in a case where no other printer exists (NO at S2208), the system proceeds to S2209.

In a case where no other printer exists (NO at S2208), the printer driver acquisition section acquires the printer drivers for all the printers in the printers list from the storage medium or the printer driver storage apparatus (S2209), and the printer driver acquisition section supplies the acquired printer drivers to the printer driver install program (S2210), the system terminating the acquisition process.

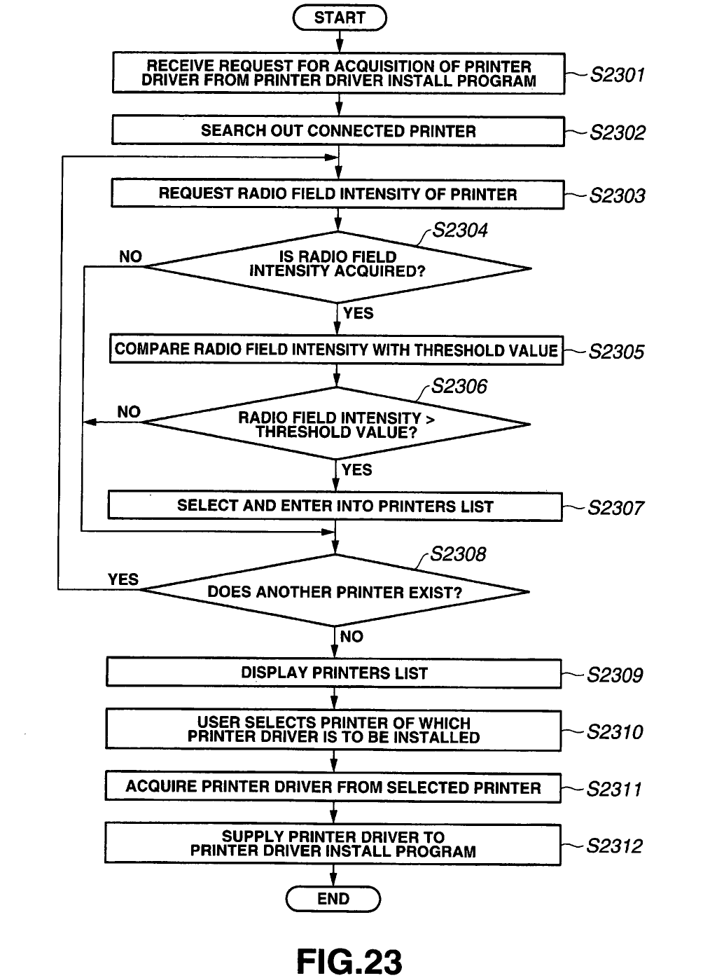

FIG. 23 is a flowchart illustrating the flow of operation of the printer driver acquisition program in a case where the printer driver for the wireless printer which is selected from the printers list by the user is to be acquired.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When a request for acquisition of the printer driver is received from the printer driver install program which is activated (S2301), the printer search section searches out a printer connected to the PC regardless of whether the connection is wired or wireless (S2302); the radio field intensity acquisition section requests the radio field intensity of the searched-out printer (S2303); and in a case where the radio field intensity is acquired (YES at S2304), the system proceeds to S2305, while, in a case where the radio field intensity cannot be acquired (NO at S2304), the system proceeds to S2308.

In a case where the radio field intensity is acquired (YES at S2304), the printer selection section compares the acquired radio field intensity with the threshold value (S2305), and in a case where the radio field intensity is higher than the threshold value (YES at S2306), the system proceeds to S2307, while, in a case where the radio field intensity is lower than the threshold value (NO at S2306), the system proceeds to S2308.

In a case where the radio field intensity is higher than the threshold value (YES at S2306), the printer selection section selects the printer having the radio field intensity to enter it into the printers list (S2307), the system proceeding to S2308.

And, in a case where another printer exists (YES at S2308), the system returns to S2303, while, in a case where no other printer exists (NO at S2308), the system proceeds to S2309.

In a case where no other printer exists (NO at S2308), a printers list is displayed on the display apparatus (S2309). The printers list is displayed on, for example, the screen 26 as shown in FIG. 5.

And, the user selects the printer of which printer driver is to be installed (S2310); the printer driver acquisition section acquires the printer driver for the selected printer from the storage medium or the printer driver storage apparatus (S2311); and the printer driver acquisition section supplies the acquired printer driver to the printer driver install program (S2312), the system terminating the installation process.

The printer driver install program can be supplied by storing on storage media, such as various memories, optical disks, and the like, and can also be distributed through a communication line.

### Eight Exemplary Embodiment

In an eighth exemplary embodiment, an example will be described in which the information processing apparatus program (hereinafter referred to as the “printer driver acquisition program”) pertaining to the present invention that is installed in the PC 2 identifies, by identifying the connection style of the printer to be connected, a wireless printer with which wireless communication are to be performed, and reads out the printer driver for the wireless printer from the storage medium (for example, a memory, an optical disk, or the like) which is set in the PC 2 and which holds the printer drivers for each of the printers, or acquires the printer driver for the wireless printer from the printer driver storage apparatus connected to the communication system 1 and which holds the printer drivers for each the printers.

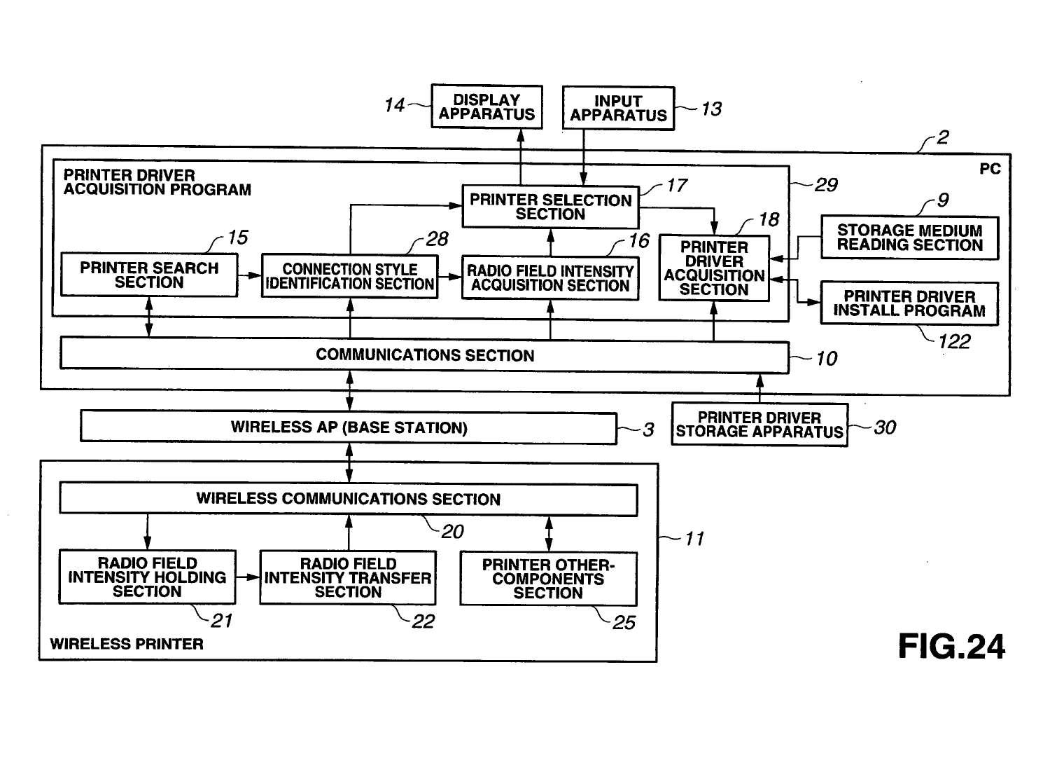

FIG. 24 is a block diagram illustrating an example of the functional configuration of the PC 2 and the wireless printer 11.

First, the functional configuration of the PC 2 will be described.

As shown in FIG. 24, a printer driver acquisition program 29, a printer driver install program 122, and various types of application software (not shown) for realizing application programs are installed in the PC 2, and these utilize the functions of the OS (not shown) for implementing various types of process under the control of the OS. In addition, input apparatuses 13, such as a keyboard and a mouse, and a display apparatus 14, such as a display, are connected to the PC 2. The components other than the above-described components of the PC 2 are not shown, and thus description thereof is omitted.

Next, the functional configuration of the printer driver acquisition program 29 will be described.

As shown in FIG. 24, the printer driver acquisition program 29 includes a printer search section 15, a connection style identification section 28, a radio field intensity acquisition section 16, a printer selection section 17, and a printer driver acquisition section 18 as the functions thereof.

The printer search section 15 searches out a printer connected to the PC 2 regardless of whether the connection is wired or wireless.

The connection style identification section 28 identifies the connection style of the printer searched out by the printer search section 15 (in other words, whether the connection is wireless or wired). Herein, the printer driver acquisition program 29 will not acquire the printer driver from the printer which connection style is identified to be wired.

The radio field intensity acquisition section 16 acquires the radio field intensity (or the communication level) for wireless communication from the wireless printer 11 of which connection style is identified to be wireless by the connection style identification section 28.

The printer selection section 17 compares the radio field intensity acquired from the wireless printer 11 with a prescribed value (hereinafter referred to as a “threshold value”) to select and enter into a list (hereinafter referred to as a “printers list”) the wireless printer 11 having a radio field intensity higher than the threshold value as the wireless printer 11 of which printer driver is to be acquired. The user can set the threshold value.

The printer driver acquisition section 18 acquires the printer driver for the wireless printer 11 in the printers list which is selected by the printer selection section 17, from the storage medium reading section 9 or the printer driver storage apparatus 30. In a case where the printer driver is to be acquired from the storage medium reading section 9, the storage medium reading section 9 reads out only the printer driver for the wireless printer in the printers list from the storage medium set in the PC 2, and the printer driver acquisition section 18 acquires the read-out printer driver. On the other hand, in a case where the printer driver is acquired from the printer driver storage apparatus 30, the printer driver acquisition section 18 accesses the printer driver storage apparatus 30 through the communication section 10, and acquires only the printer driver for the wireless printer in the printers list. In addition, there may be two cases to acquire the printer driver: the first case is that the printer driver may be acquired from all the wireless printers 11 in the printers list selected by the printer selection section 17; and, the second case is that the printer driver may be acquired from the wireless printer 11 selected by the user in a way that the wireless printers in the printers list selected by the printer selection section 17 are displayed on the display device 14, and using the input device 13, the user selects from the printers list displayed on the display device 14 the wireless printer 11 of which the printer driver is to be installed.

The functional configuration of the wireless printer 11 is the same as that of the wireless printer 11 as described in the fifth, the sixth and the seventh exemplary embodiments, thus description thereof is omitted herein.

Next, the operation of the printer driver acquisition program 29 and that of the wireless printer 11 will be described.

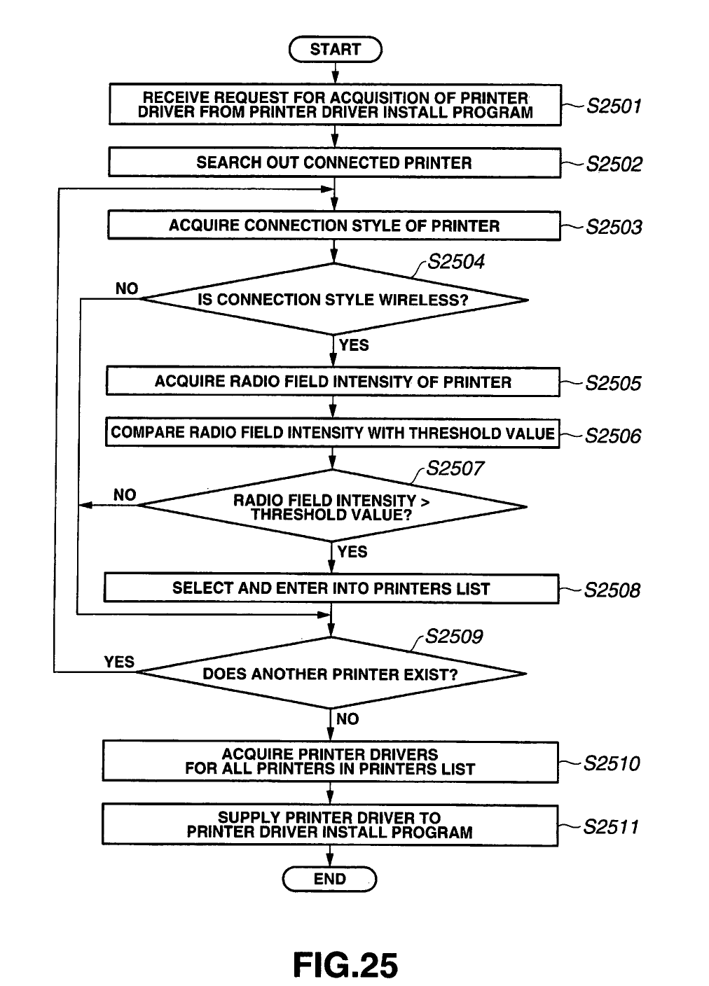

FIG. 25 is a flowchart illustrating the flow of operation of the printer driver acquisition program in a case where the printer drivers for all the wireless printers in the printers list are to be acquired.

The printer driver install program is generally activated by the user instruction (for example, an instruction given by clicking the icon representing the printer driver install program that is displayed on the desktop of the PC, an instruction given by clicking the printing pushbutton prepared by an application program during data processing carried out thereby, or the like), however, in a case where the printer driver install program is a resident program, the install program may be activated at the time of system start-up.

When a request for acquisition of the printer driver is received from the printer driver install program which is activated (S2501), the printer search section searches out a printer connected to the PC regardless of whether the connection is wired or wireless (S2502); the connection style identification section acquires the connection style from the searched-out printer (S2503); in a case where the connection style is identified to be wireless (YES at S2504), the system proceeds to S2505, while, in a case where the connection style is identified to be wired (NO at S2504), the system proceeds to S2509.

In a case where the connection style is identified to be wireless (YES at S2504), the radio field intensity acquisition section requests the radio field intensity of the printer which is identified to be wireless (S2505); the printer selection section compares the acquired radio field intensity with the threshold value (S2506); in a case where the radio field intensity is higher than the threshold value (YES at S2507), the system proceeds to S2508, while, in a case where the radio field intensity is lower than the threshold value (NO at S2507), the system proceeds to S2509.

In a case where the radio field intensity is higher than the threshold value (YES at S2507), the printer selection section selects the printer having the radio field intensity to enter it into the printers list (S2508), the system proceeding to S2509.

And, in a case where another printer exists (YES at S2509), the system returns to S2503, while, in a case where no other printer exists (NO at S2509), the system proceeds to S2510.

In a case where no other printer exists (NO at S2509), the printer driver acquisition section acquires the printer drivers for all the printers in the printers list from the storage medium or the printer driver storage apparatus (S2510), and the printer driver acquisition section supplies the acquired printer drivers to the printer driver install program (S2511), the system terminating the acquisition process.

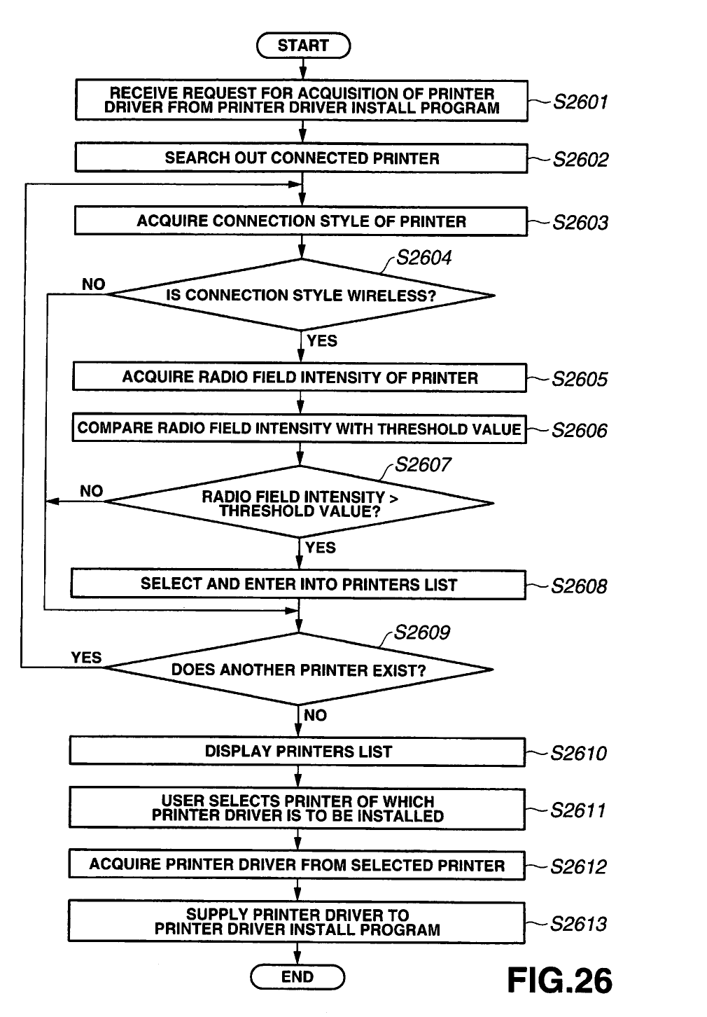

FIG. 26 is a flowchart illustrating the flow of operation of the printer driver acquisition program in a case where the printer driver for the wireless printer which is selected from the printers list by the user is to be acquired.

The printer driver install program is generally activated by the user instruction (for example, an instruction given by clicking the icon representing the printer driver install program displayed on the desktop of the PC, an instruction given by clicking the printing pushbutton prepared by an application program during data processing carried out thereby, or the like), however, in a case where the printer driver install program is a resident program, the install program may be activated at the time of system start-up.

When a request for acquisition of the printer driver is received from the printer driver install program which is activated (S2601), the printer search section searches out a printer connected to the PC regardless of whether the connection is wired or wireless (S2602); the connection style identification section acquires the connection style from the searched-out printer (S2603); in a case where the connection style is identified to be wireless (YES at S2604), the system proceeds to S2605, while, in a case where the connection style is identified to be wired (NO at S2604), the system proceeds to S2609.

In a case where the connection style is identified to be wireless (YES at S2604), the radio field intensity acquisition section requests the radio field intensity of the printer identified to be wireless (S2605); the printer selection section compares the acquired radio field intensity with the threshold value (S2606); in a case where the radio field intensity is higher than the threshold value (YES at S2607), the system proceeds to S2608, while, in a case where the radio field intensity is lower than the threshold value (NO at S2607), the system proceeds to S2609.

In a case where the radio field intensity is higher than the threshold value (YES at S2607), the printer selection section selects the printer having the radio field intensity to enter it into the printers list (S2608), the system proceeding to S2609.

And, in a case where another printer exists (YES at S2609), the system returns to S2603, while, in a case where no other printer exists (NO at S2609), the system proceeds to S2610.

In a case where no other printer exists (NO at S2609), a printers list is displayed on the display apparatus (S2610). The printers list is displayed on, for example, the screen 26 as shown in FIG. 5.

And, the user selects the printer of which printer driver is to be installed (S2611); the printer driver acquisition section acquires the printer driver for the selected printer from the storage medium or the printer driver storage apparatus (S2612); and the printer driver acquisition section supplies the acquired printer driver to the printer driver install program (S2613), the system terminating the installation process.

The printer driver install program can be supplied, being stored on storage media, such as various memories, optical disks, and the like, and can also be distributed through a communication line.

An information processing apparatus program, which causes an information processing apparatus to implement processes, includes: an acquisition request reception process that, from a device control program setting program that sets the device control program for controlling a device connected through a communication section, via the communication section, so as to be available, receives an acquisition request for the device control program; a device search process that searches out a device connected through the communication section; a connection style identification process that identifies the style of the connection with the communication section of the device searched out by the device search process; a radio field intensity acquisition process that, from a device for which the connection style identified to be wireless communication by the connection style identification process, acquires the radio field intensity for wireless communication of the device; a device selection process that, according to the radio field intensity acquired by the radio field intensity acquisition process, selects a device; a device control software acquisition process that acquires the device control program for the device selected by the device selection process; and a device control program supply process that supplies the device control program acquired by the device control program acquisition process to the device control program setting program, whereby it is made possible to easily utilize devices which are connected by wireless communication.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus, comprising:
a device search section that searches a device connected through a communication section;
a radio field intensity acquisition section that acquires from the device searched by the device search section a radio field intensity of the device for wireless communication with the communication section;
a device selection section that selects a device in accordance with the radio field intensity acquired by the radio field intensity acquisition section;
a device control program acquisition section that acquires a device control program for the device selected by the device selection section; and
a device control program setting section that sets the device control program acquired by the device control program acquisition section so as to be available.

2. A communication system, comprising at least one device connected through a communication section, and an information processing apparatus that controls the device via the communication section, in which
the device comprises:
a wireless communication control section connected to the communication section through wireless communication;
a radio field intensity holding section that holds the radio field intensity for the wireless communication; and
a radio field intensity transfer section that transfers to the information processing apparatus the radio field intensity held in the radio field intensity holding section in accordance with a request from the information processing apparatus for transfer of the radio field intensity; and
the information processing apparatus comprises:
a device search section that searches a device connected through the communication section;
a radio field intensity acquisition section that acquires from the device searched by the device search section the radio field intensity of the device for wireless communication with the communication section;
a device selection section that selects a device in accordance with the radio field intensity acquired by the radio field intensity acquisition section;
a device control software acquisition section that acquires the device control program for the device selected by the device selection section; and
a device control program setting section that sets the device control program acquired by the device control program acquisition section so as to be available.

3. A computer readable recording medium storing an information processing device program causing an information processing device to execute a process, the process comprising:
searching a device connected through a communication section;
acquiring from the searched device a radio field intensity of the device for wireless communication with the communication section;
selecting a device in accordance with the acquired radio field intensity;
acquiring a device control program for the selected device; and
setting the acquired device control program so as to be available.

4. A computer readable recording medium storing an information processing device program causing an information processing device to execute a process, the process comprising:
receiving an acquisition request for a device control program for controlling, via a communication section, a device connected through the communication section from a device control program setting program that sets the device control program so as to be available;
searching the device connected through the communication section;
acquiring from the searched device the radio field intensity of the device for wireless communication with the communication section;
selecting a device in accordance with the acquired radio field intensity;
acquiring the device control program for the selected device; and
supplying the acquired device control program to the device control program setting program.

5. A computer data signal embodied in a carrier wave for enabling a computer to perform a process for an information processing device, the process comprising:
searching a device connected through a communication section;
acquiring from the searched device a radio field intensity of the device for wireless communication with the communication section;
selecting a device in accordance with the acquired radio field intensity;
acquiring a device control program for the selected device; and
setting the acquired device control program so as to be available.

6. A computer data signal embodied in a carrier wave for enabling a computer to perform a process for an information processing device, the processing comprising:
receiving an acquisition request for a device control program for controlling, via a communication section, a device connected through the communication section from a device control program setting program that sets the device control program so as to be available;
searching the device connected through the communication section;
acquiring from the searched device the radio field intensity of the device for wireless communication with the communication section;
selecting a device in accordance with the acquired radio field intensity;
acquiring the device control program for the selected device; and
supplying the acquired device control program to the device control program setting program.
